(19) United States
(12) Patent Application Publication
(10) Pub. No.: US 2025/0278881 A1
(43) Pub. Date: Sep. 4, 2025

(54) METHOD AND APPARATUS FOR GENERATING MOTION OF VIRTUAL CHARACTER, AND METHOD AND APPARATUS FOR CONSTRUCTING MOTION LIBRARY OF VIRTUAL CHARACTER

(71) Applicant: Tencent Technology (Shenzhen) Company Limited, Shenzhen (CN)

(72) Inventors: Jiaxuan ZHUO, Shenzhen (CN); Yu LU, Shenzhen (CN); Xinghui FU, Shenzhen (CN); Zhongqian SUN, Shenzhen (CN)

(73) Assignee: Tencent Technology (Shenzhen) Company Limited, Shenzhen (CN)

(21) Appl. No.: 19/213,591

(22) Filed: May 20, 2025

Related U.S. Application Data
(63) Continuation of application No. PCT/CN2024/093505, filed on May 15, 2024.

(30) Foreign Application Priority Data
May 15, 2023 (CN) 202310547509.7

(51) Int. Cl. G06T 13/20; G06F 16/65; G06F 40/253; G06F 40/284; G06F 40/30; G06T 13/40

(52) U.S. Cl. CPC G06T 13/205; G06F 16/65; G06F 40/253; G06F 40/284; G06F 40/30; G06T 13/40

(57) ABSTRACT

A method and an apparatus for generating a motion of a virtual character, and a method and an apparatus for constructing a motion library of a virtual character are provided, and belong to the field of computer technologies. The method for generating a motion of a virtual character includes: obtaining audio and text of a virtual character, the text indicating semantic information of the audio (201); determining a semantic tag of the text based on the text (202); retrieving a motion category matching the semantic tag and motion data belonging to the motion category from a preset motion library (203); and generating a motion sequence of the virtual character based on the motion data (204).

### RELATED APPLICATION

This application claims priority to PCT/CN2024/093505, filed on May 15, 2024, which is based on and claims the benefit of priority to Chinese Patent Application No. 202310547509.7, filed on May 15, 2023 and entitled “METHOD AND APPARATUS FOR GENERATING MOTION OF VIRTUAL CHARACTER, AND METHOD AND APPARATUS FOR CONSTRUCTING MOTION LIBRARY OF VIRTUAL CHARACTER”, which are incorporated herein by reference in their entireties.

### FIELD OF THE TECHNOLOGY

This application relates to the field of computer technologies, and in particular, to a method and an apparatus for generating a motion of a virtual character, and a method and an apparatus for constructing a motion library of a virtual character.

### BACKGROUND OF THE DISCLOSURE

With the development of computer technologies, virtual characters are more widely applied to aspects such as live streaming, movie and television, animation, gaming, virtual social networking, and human-computer interaction. By using a live streaming scenario as an example, a virtual character serves as an anchor for broadcasting or conversation. To improve a rendering effect of the virtual character, motion generation of the virtual character is involved.

### SUMMARY

Embodiments of this disclosure provide a method and an apparatus for generating a motion of a virtual character, and a method and an apparatus for constructing a motion library of a virtual character, which can rapidly and efficiently synthesize a more accurate motion sequence for a virtual character, thereby improving motion generation efficiency of the virtual character. The technical solutions are as follows.

According to an aspect, a method for generating a motion of a virtual character is provided, applied to a computer device. The method includes:
obtaining audio and text of a virtual character, the text indicating semantic information of the audio;
determining a semantic tag of the text based on the text, the semantic tag representing at least one of part-of-speech information of a token in the text or sentiment information expressed by the text;
retrieving a motion category matching the semantic tag and motion data belonging to the motion category from a preset motion library, the preset motion library including motion data of the virtual character belonging to a plurality of motion categories; and
generating a motion sequence of the virtual character based on the motion data, the motion sequence being configured for controlling the virtual character to perform motions matching the audio.

According to an aspect, a method for constructing a motion library of a virtual character is provided, applied to a computer device. The method includes:
obtaining a sample motion sequence, reference audio, and reference text of each sample character, the reference text indicating semantic information of the reference audio, and the sample motion sequence being configured for controlling the sample character to perform motions matching the reference audio;
dividing the sample motion sequence into a plurality of sample motion clips based on an association relationship between tokens in the reference text and phones in the reference audio, each sample motion clip being associated with one token in the reference text and one phone in the reference audio;
clustering each sample motion clip of each sample character based on motion features of the sample motion clips, to obtain a plurality of motion sets, each motion set indicating motion data belonging to a same motion category and belonging to different sample characters; and
constructing a motion library based on the plurality of motion sets.

According to an aspect, an apparatus for generating a motion of a virtual character is provided. The apparatus includes:
an obtaining module, configured to obtain audio and text of a virtual character, the text indicating semantic information of the audio;
an analysis module, configured to determine a semantic tag of the text based on the text, the semantic tag representing at least one of part-of-speech information of a token in the text or sentiment information expressed by the text;
a retrieval module, configured to retrieve a motion category matching the semantic tag and motion data belonging to the motion category from a preset motion library, the preset motion library including motion data of the virtual character belonging to a plurality of motion categories; and
a generation module, configured to generate a motion sequence of the virtual character based on the motion data, the motion sequence being configured for controlling the virtual character to perform motions matching the audio.

According to an aspect, an apparatus for constructing a motion library of a virtual character is provided. The apparatus includes:
a sample obtaining module, configured to obtain a sample motion sequence, reference audio, and reference text of each sample character, the reference text indicating semantic information of the reference audio, and the sample motion sequence being configured for controlling the sample character to perform motions matching the reference audio;
a clip division module, configured to divide the sample motion sequence into a plurality of sample motion clips based on an association relationship between tokens in the reference text and phones in the reference audio, each sample motion clip being associated with one token in the reference text and one phone in the reference audio;
a clustering module, configured to cluster each sample motion clip of each sample character based on motion features of the sample motion clips, to obtain a plurality of motion sets, each motion set indicating motion data belonging to a same motion category and belonging to different sample characters; and
a construction module, configured to construct a motion library based on the plurality of motion sets.

According to an aspect, a computer device is provided, including one or more processors and one or more memories, the one or more memories having at least one computer program stored therein, the at least one computer program being loaded and executed by the one or more processors to implement the method for generating a motion of a virtual character or the method for constructing a motion library of a virtual character according to any one of the foregoing possible implementations.

According to an aspect, a computer-readable storage medium is provided, having at least one computer program stored therein, the at least one computer program being loaded and executed by a processor to implement the method for generating a motion of a virtual character or the method for constructing a motion library of a virtual character according to any one of the foregoing possible implementations.

According to an aspect, a computer program product is provided, including one or more computer programs, the one or more computer programs being stored in a computer-readable storage medium. One or more processors of a computer device can read the one or more computer programs from the computer-readable storage medium, and the one or more processors execute the one or more computer programs, to cause the computer device to perform the method for generating a motion of a virtual character or the method for constructing a motion library of a virtual character according to any one of the foregoing possible implementations.

### BRIEF DESCRIPTION OF THE DRAWINGS

To describe the technical solutions in embodiments of this disclosure more clearly, the following briefly describes the accompanying drawings required for describing the embodiments. Apparently, the accompanying drawings in the following descriptions show merely some embodiments of this disclosure, and a person of ordinary skill in the art can derive other drawings from these accompanying drawings without creative efforts.

FIG. 1 is a schematic diagram of an implementation environment of a method for generating a motion of a virtual character according to an embodiment of this disclosure.

FIG. 2 is a flowchart of a method for generating a motion of a virtual character according to an embodiment of this disclosure.

FIG. 3 is a flowchart of a method for generating a motion of a virtual character according to an embodiment of this disclosure.

FIG. 4 is a principle diagram of a method for generating a motion of a virtual character according to an embodiment of this disclosure.

FIG. 5 is a flowchart of a method for constructing a motion library of a virtual character according to an embodiment of this disclosure.

FIG. 6 is a principle diagram of a method for creating a motion library according to an embodiment of this disclosure.

FIG. 7 is a principle diagram of data cleaning for a motion set according to an embodiment of this disclosure.

FIG. 8 is a principle diagram of data supplement of a newly added motion clip according to an embodiment of this disclosure.

FIG. 9 is a schematic structural diagram of an apparatus for generating a motion of a virtual character according to an embodiment of this disclosure.

FIG. 10 is a schematic structural diagram of an apparatus for constructing a motion library of a virtual character according to an embodiment of this disclosure.

FIG. 11 is a schematic structural diagram of a computer device according to an embodiment of this disclosure.

### DESCRIPTION OF EMBODIMENTS

To make the objectives, technical solutions, and advantages of this disclosure clearer, implementations of this disclosure are further described below in detail with reference to the accompanying drawings.

The terms “first”, “second”, and the like in this disclosure are used for distinguishing between same items or similar items of which effects and functions are basically the same. The “first”, “second”, and “n^{th}” do not have a dependency relationship in logic or time sequence, and a quantity and an execution order thereof are not limited.

In this disclosure, the term “at least one” means one or more, and the term “a plurality of” means two or more. For example, a plurality of motion clips mean two or more motion clips.

In this disclosure, the term “including at least one of A or B” relates to the following cases: Only A is included, only B is included, and both A and B are included.

User-related information (including but not limited to device information, personal information, behavior information, and the like of a user), data (including but not limited to data configured for analysis, stored data, displayed data, and the like), and signals involved in this disclosure, when applied to specific products or technologies by using the method in the embodiments of this disclosure, are all permitted, agreed, authorized by the user or fully authorized by all parties, and the collection, use and processing of relevant information, data, and signals need to comply with relevant laws, regulations, and standards of relevant countries and regions. For example, motion data of a virtual character involved in this disclosure is obtained under full authorization.

Artificial intelligence (AI) is a theory, method, technology, and application system that uses a digital computer or a machine controlled by the digital computer to simulate, extend, and expand human intelligence, perceive an environment, obtain knowledge, and use knowledge to obtain an optimal result. In other words, the artificial intelligence is a comprehensive technology of computer science, which attempts to understand the essence of intelligence and produce a new type of intelligent machine that can react in a similar way to human intelligence. The artificial intelligence is to study design principles and implementation methods of various intelligent machines, so that the machines have the functions of perception, reasoning, and decision-making.

The artificial intelligence technology is a comprehensive discipline, covering a wide range of fields including both a hardware-level technology and a software-level technology. The basic artificial intelligence technology generally includes technologies such as sensors, dedicated artificial intelligence chips, cloud computing, distributed storage, big data processing technologies, operating/interaction systems, and mechatronics. Artificial intelligence software technologies mainly include a computer vision technology, a speech processing technology, a natural language processing technology, machine learning/deep learning, unmanned driving, smart transportation, and the like.

To make a computer capable of listening, seeing, speaking, and feeling is the future development direction of human-computer interaction, and speech has become one of the most promising human-computer interaction methods in the future. Key technologies of the speech technology include an automatic speech recognition (ASR) technology, a text-to-speech technology, a voiceprint recognition technology, and the like.

Machine learning (ML) is a multi-field interdisciplinary subject involving the probability theory, statistics, the approximation theory, convex analysis, the algorithm complexity theory, and the like. The machine learning specializes in studying how a computer simulates or implements a human learning behavior to obtain new knowledge or skills, and reorganize an existing knowledge structure, to keep improving its performance. The machine learning is a core of the artificial intelligence, is a basic way to make the computer intelligent, and is applied to various fields of the artificial intelligence. The machine learning and deep learning generally include technologies such as an artificial neural network, a belief network, reinforcement learning, transfer learning, inductive learning, and learning from demonstrations.

Natural language processing (NLP) is an important direction in the field of computer technologies and the field of artificial intelligence. Natural language processing studies various theories and methods for implementing effective communication between human and computers through natural languages. Natural language processing is a science that integrates linguistics, computer science and mathematics. Therefore, studies in this field relate to natural languages, that is, languages used by people in daily life, and natural language processing is closely related to linguistic studies. The natural language processing technology generally includes technologies such as text processing, semantic understanding, machine translation, robot question and answer, and knowledge graph.

With the research and progress of the artificial intelligence technology, the artificial intelligence technology is studied and applied in a plurality of fields such as a common smart home, a smart wearable device, a virtual assistant, a smart speaker, smart marketing, unmanned driving, automatic driving, an unmanned aerial vehicle, a robot, smart medical care, smart customer service, and smart transportation. It is believed that with the development of technologies, the artificial intelligence technology will be applied to more fields, and play an increasingly important role.

Solutions provided in the embodiments of this disclosure relate to artificial intelligence speech technologies, NLP, and machine learning, and specifically relate to application to motion generation of a virtual character by using the foregoing technologies or a combination thereof, which are described in the following embodiments.

Terms involved in the embodiments of this disclosure are described below.

Virtual character: An object movable in a virtual world. The virtual character is a virtual and personified digital character in the virtual world, for example, a virtual person, an animation person, or a virtual role. The virtual character may be a three-dimensional model. The three-dimensional model may be a three-dimensional role constructed based on a three-dimensional human skeleton technology. In some embodiments, the virtual character may alternatively be implemented by using a 2.5-dimensional model or a 2-dimensional model. This is not limited in the embodiments of this disclosure. The 3D model of the virtual character may be manufactured by using Miku Miku Dance (MMD, a type of three-dimensional computer graphics software), a Unity engine, or the like. Certainly, the 2D model of the virtual character may also be manufactured by using Live2D (a type of two-dimensional computer graphics software). A dimension of the virtual character is not specifically limited herein.

Metaverse: It is also referred to as a post-universe, a shape universe, a super-sensory space, or a virtual space, and focuses on a network of a 3D virtual world with social links. The metaverse relates to a persistent and decentralized online three-dimensional virtual environment.

Digital Human: A virtual character generated by performing 3D modeling on a human body by using an information science method, to simulate the human body. For another expression, the digital human is a digital person character that is created by using a digital technology and that is close to a human character. The digital human is widely applied to scenarios such as video creation, live streaming, industry broadcasting, social entertainment, and voice prompting. For example, the digital human may serve as a virtual anchor, a virtual avatar, or the like. The digital human is also referred to as a virtual person, a virtual digital human, or the like.

Virtual anchor: An anchor that uses a virtual character to perform a manuscript activity on a video website, for example, a virtual YouTuber (VTuber) or a virtual Uploader (VUP). Usually, the virtual anchor performs activities on a video website or a social platform in an original virtual personality setting and character. The virtual anchor may implement various forms of human-computer interaction such as broadcasting, performing, live streaming, and conversation.

Person inside: A person performing performance or manipulating a virtual anchor behind the scene during live streaming. For example, body motions and facial expressions of the person inside are captured by using an optical motion capture system with the help of sensors mounted on the head and body of the person inside, and motion data is synchronized to the virtual anchor. In this way, real-time interaction between the virtual anchor and audience watching the live streaming can be implemented with the help of a real-time motion capture mechanism.

Motion capture (MoCap): It is also referred to as movement capture. This means that sensors are arranged on key parts of a moving object or a real person, a motion capture system captures positions of the sensors, and then motion data of three-dimensional space coordinates is obtained after computer processing. After the motion data is identified by a computer, the motion data may be applied to fields such as animation manufacturing, gait analysis, biomechanics, and ergonomics. A common motion capture device includes a motion capture suit, which is mostly applicable to motion generation of a 3D virtual character. The real person performs motions by wearing the motion capture suit, to migrate 3D skeleton data of a human body captured by the motion capture system to a 3D model of a virtual character, to obtain 3D skeleton data of the virtual character. The 3D skeleton data of the virtual character is configured for controlling the 3D model of the virtual character to perform motions the same as those of the real person.

Optical motion capture: An instrument used in the field of engineering and technologies related to information and system science.

Inertial motion capture: Motions of main skeletal parts of a human body may be measured in real time by using inertial sensors, then positions of joints of the human body are calculated according to an inverse kinematics principle, and data is applied to a corresponding (virtual character) skeleton.

Tokenization: A piece of given text is decomposed into a data structure in which a token is used as a unit, and each token includes one or more characters.

Token: Tokenization is performed on a piece of given text, to decompose the text into a token list, where each element in the token list is a Token obtained through tokenization, and each Token includes one or more characters. For example, tokenization is performed on text “I am happy”, to obtain a Token list {“I”, “happy”, “happy”}.

Phone: A minimum speech unit obtained through segmentation according to natural attributes of speech, which is analyzed according to pronunciation motions in a synopsis. One motion forms one phone. For example, each character in a token may be decomposed into one or more phones according to a pronunciation motion.

Phone alignment: A piece of audio and text corresponding to semantics of the audio are given, and a phone of each character in the text is decomposed and aligned with each audio frame in an audio timeline. To be specific, for each character in the text, one or more phones are determined according to a pronunciation motion of the character, and then one or more audio frames in which each phone is sounded are found from the audio. In this way, all audio frames covered by all phones that need to be sounded to speak the character form an audio clip. A timestamp interval of the audio clip in the audio timeline is found, which reflects a timestamp interval in which a speaker speaks the character.

Frame interpolation: It is a motion pre-estimation and motion compensation manner, and can extend a quantity of motion frames of a motion clip when a quantity of frames is insufficient, so that motions become coherent. For example, a new motion frame is interpolated into every two original motion frames of a motion clip, and an intermediate state of a motion change in the two motion frames is supplemented with the new motion frame.

Text sentiment analysis: A piece of text is given, and a sentiment tag having a highest matching degree with the text is usually outputted in a process of analyzing, processing, summarizing, and reasoning the text. Therefore, the text sentiment analysis is also referred to as opinion mining or tendency analysis. According to different granularities of text processing, sentiment analysis may be roughly divided into three research levels: token-level, sentence-level, and chapter-level. Text sentiment analysis approaches may be roughly grouped into four types: keyword identification, token association, statistical methods, and concept-level technologies.

Technical concepts in the embodiments of this disclosure are described below.

With the rapid development of technologies such as three-dimensional (3D) modeling, virtual reality (VR), augmented reality (AR), and metaverse, virtual characters are more widely applied to aspects such as live streaming, movie and television, animation, gaming, virtual social networking, and human-computer interaction.

By using a live streaming scenario as an example, a virtual character serves as an anchor for broadcasting or conversation. To improve a rendering effect of the virtual character, motion generation of the virtual character is involved. Similarly, in a video creation scenario, creation of a submission video of a virtual anchor, creation of a digital human video, and the like also involve motion generation of virtual characters.

Usually, during generation of a body motion of a virtual character, a motion capture manner is used: A real person (or referred to as an actor) wears a motion capture suit with sensors arranged on the full body, and the real person performs motion performance according to script content and script audio. The motion capture suit captures motion data of the performance of the real person (that is, 3D skeleton data of a human body), and reports the motion data to a computer online with the motion capture suit. The computer migrates the 3D skeleton data of the human body to a 3D model of the virtual character, to obtain 3D skeleton data of the virtual character. Later, the 3D skeleton data of the virtual character forms a motion sequence at consecutive moments, and then a professional animator performs some jitter or correction on the motion sequence of the virtual character, to perform motion restoration on the virtual character, to finally obtain a series of virtual character motion representations that are to be included in a script. In the foregoing motion generation manner based on motion capture, the entire process needs manual intervention, and 3D skeleton data of a human body captured each time is customized according to a particular script, cannot be repeatedly used, and does not have universality. In other words, once a piece of audio or text that does not exist in the script occurs, motion generation cannot be implemented, and an actor needs to use the new audio or text as a new script to perform performance. Therefore, the motion generation efficiency is low.

In addition, during generation of a body motion of a virtual character, video motion capture may be performed by using a large number of public 2D video materials (for example, lexicon video and talk show videos), to obtain 2D video data. Then, the 2D video data is converted into 3D skeleton data, and a training data set is constructed by using the 3D skeleton data and audio and text labeled for the 3D skeleton data, to train a motion generation model, so that the motion generation model can generate the body motion of the virtual character under audio driving. However, because a data source is simple and a human body motion has high complexity, an effect of the motion generation model is not ideal, and a finally synthesized virtual character has problems such as flatness of body motions and inaccurate performance. Consequently, the motion generation accuracy is poor.

In view of this, an embodiment of this disclosure provides a method for constructing a motion library of a virtual character. Sample motion sequences of a large number of sample characters, and reference text and reference audio of the sample motion sequences can be acquired; the sample motion sequences are divided into sample motion clips according to the reference text and the reference audio, and the sample motion clips are matched to motion categories to which the sample motion clips belong; and then motion data cleaning, motion data filtering, or the like is performed on a motion set of each motion category, to finally construct a perfect motion library of a virtual character. The motion library can cover many motion categories. Then, based on the constructed motion library, an audio-triggered body motion generation algorithm framework can be provided. During real-time motion generation of a virtual character, a user only needs to give a piece of audio and text that the user intends to interpret, so that a machine can rapidly implement audio-and-text-triggered body motion 3D data generation, and output a motion sequence of the virtual character. The entire motion generation process does not need manual intervention, and the machine can rapidly and precisely generate the motion sequence matching the audio and the text, which has high motion generation efficiency and high motion generation accuracy.

If semantic information about a text modality is not considered and a motion clip is queried according to only a similarity with inputted audio to synthesize a motion sequence, a final body motion only changes simply according to an audio tempo, and cannot reflect a body motion at a real semantic level. In addition, a conversation motion effect can be simply repeated, and semantic accuracy and richness cannot be presented. In this way, apparently, the motion generation effect is poor, and the virtual character simulation degree is poor.

However, in the foregoing technical solution, because information about dual modalities of audio and text is considered to drive generation of the body motion of the virtual character, and an association relationship between the text and the audio is considered, rich semantic motions are matched from a preset motion library under guidance of text semantics. In this way, in the synthesized motion sequence, body motion representations of the virtual character are more accurate, rich, and vivid, and can be applied to various scenarios in which a virtual character needs to perform a motion, for example, scenarios such as virtual live streaming and a digital human video. In this way, accuracy of the motion capture level is achieved, but the motion generation efficiency thereof is far better than that of the motion capture manner.

An implementation environment of the embodiments of this disclosure is described below.

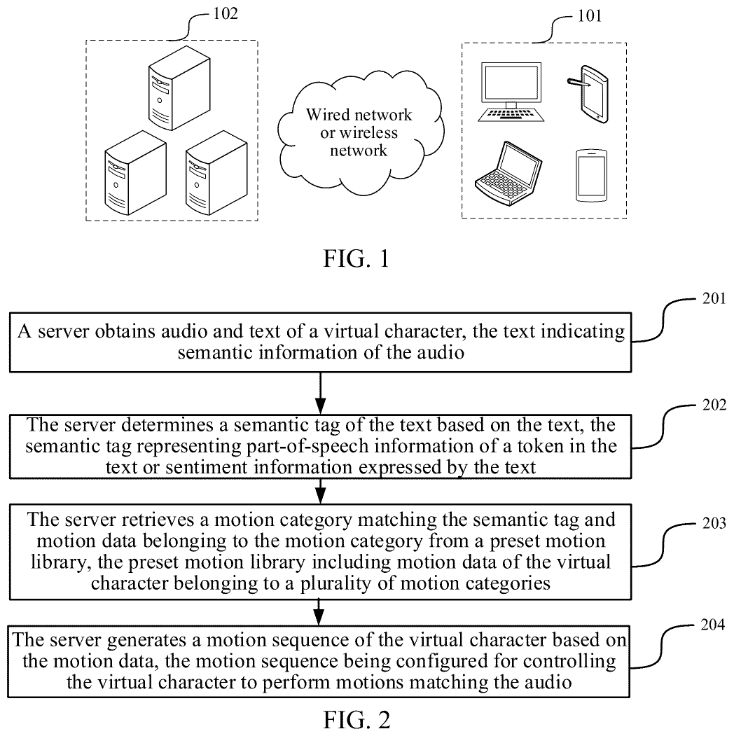

FIG. 1 is a schematic diagram of an implementation environment of a method for generating a motion of a virtual character according to an embodiment of this disclosure. Referring to FIG. 1, the implementation environment includes a terminal 101 and a server 102. The terminal 101 and the server 102 are directly or indirectly connected by using a wireless network or wired network. This is not limited in this disclosure.

An application supporting a virtual character is installed on the terminal 101. The terminal 101 can implement a function such as body motion generation of the virtual character by using the application. Certainly, the application can also have other functions such as a social networking function, a video sharing function, a video submission function, and a chat function. The application is a native application in an operating system of the terminal 101, or an application provided by a third party. For example, the application includes, but is not limited to: a live streaming application, a short video application, an audio/video application, a game application, a social application, a 3D animation application, or another application. This is not limited in the embodiments of the present disclosure.

In some embodiments, the terminal 101 is a smartphone, a tablet computer, a notebook computer, a desktop computer, a smart speaker, a smartwatch, or the like, but is not limited thereto.

The server 102 provides a background service for the application supporting the virtual character on the terminal 101. The server 102 creates and maintains a motion library of the virtual character, and caches 3D skeletal models of a plurality of virtual characters. The server 102 includes at least one of one server, a plurality of servers, a cloud computing platform, or a virtualization center. In some embodiments, the server 102 is responsible for primary motion generation computing work, and the terminal 101 is responsible for secondary motion generation computing work; or the server 102 is responsible for secondary motion generation computing work, and the terminal 101 is responsible for primary motion generation computing work; or the server 102 and the terminal 101 perform collaborative motion generation computing by using a distributed computing architecture between each other.

In some embodiments, the server 102 is an independent physical server, or is a server cluster or a distributed system formed by a plurality of physical servers, or is a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform.

The terminal 101 may be generally one of a plurality of terminals. In this embodiment of the present disclosure, only the terminal 101 is used an example for description. A person skilled in the art may learn that there may be more or fewer terminals.

In an exemplary scenario, during real-time body motion generation, a user uploads a piece of audio to the application on the terminal 101, to trigger a motion generation instruction. The terminal 101 sends a motion generation request to the server 102 in response to the motion generation instruction, where the motion generation request carries the audio. The server 102 performs automatic speech recognition (ASR) on the audio in response to the motion generation request, to obtain text indicating semantics of the audio. Then, the server 102 performs, by using the audio and the text, the method for generating a motion of a virtual character in the embodiments of this disclosure, to retrieve appropriate motion data from a preset motion library, to synthesize a motion sequence matching the audio. In this way, the terminal 101 implements motion generation of a virtual character under audio driving, but the server 102 synthesizes, by using dual-modality information of audio and text, a virtual character body motion that can represent an audio (or text) semantic level.

In another exemplary scenario, during real-time body motion generation, a user uploads a piece of text to the application on the terminal 101, to trigger a motion generation instruction. The terminal 101 sends a motion generation request to the server 102 in response to the motion generation instruction, where the motion generation request carries the text. The server 102 finds an audio source library of a virtual character in response to the motion generation request, and generates a piece of audio reading the text for the text (that is, dubs the text) from the audio source library. Then, the server 102 performs, by using the audio and the text, the method for generating a motion of a virtual character in the embodiments of this disclosure, to retrieve appropriate motion data from a preset motion library, to synthesize a motion sequence matching the text. In this way, the terminal 101 implements motion generation of the virtual character under text driving, but the server 102 synthesizes, by using dual-modality information of audio and text, a virtual character body motion that can represent an audio (or text) semantic level.

In still another exemplary scenario, during real-time body motion generation, a user uploads a piece of audio and text (that is, text representing semantic information of the audio) corresponding to the audio to the application on the terminal 101, to trigger a motion generation instruction. The terminal 101 sends a motion generation request to the server 102 in response to the motion generation instruction, where the motion generation request carries the audio and the text. In response to the motion generation request, the server 102 performs, by using the audio and the text, the method for generating a motion of a virtual character in the embodiments of this disclosure, to retrieve appropriate motion data from a preset motion library, to synthesize a motion sequence matching the audio and the text. In this way, the terminal 101 implements motion generation of a virtual character under audio and text driving, but the server 102 synthesizes, by using dual-modality information of audio and text, a virtual character body motion that can represent an audio (or text) semantic level.

In the foregoing various scenarios, regardless of whether the terminal 101 provides single-modality information or dual-modality information as a driving signal, by using a conversion means between text and audio in the speech technology, the server 102 synthesizes a virtual character body motion by using dual-modality information of audio and text, so that a final motion sequence can make a rhythm in conformity with an audio tempo, can also express rich semantic information at a semantic level, and even can embody a sentimental state during broadcasting of the virtual character. Therefore, the motion generation efficiency is high, the motion generation accuracy is high, and the generated body motion matches the audio tempo well and carries rich semantic information, so that the simulation degree of the virtual character is greatly improved, and the rendering effect is greatly optimized.

The method for generating a motion of a virtual character provided in the embodiments of this disclosure is applicable to any scenario in which a virtual character body motion needs to be generated. For example, in a live streaming scenario of a digital human, a person inside does not need to be equipped with a motion capture server to perform performance, and only needs to give at least one of text or audio during interaction in the live stream, so that the digital human can be controlled to make, under driving of dual-modality information of audio and text, a body motion matching the audio and subtitles (or possibly without subtitles) in the live stream, thereby improving authenticity and interest of the live stream of the digital human. For another example, in a scenario of creating a digital human video, a body motion of a digital human matching the audio or text can be controlled to be generated provided that a user creates audio or text of the video. Then, the body motion (that is, a video picture) and the audio (that is, a video voice-over) are synthesized into a digital human video, to submit the video, publish the video, or the like, thereby improving efficiency of generating the digital human video, and improving creation convenience and flexibility. For another example, the method for generating a motion of a virtual character may alternatively be applicable to various scenarios in which a virtual character body motion needs to be generated, for example, digital human customer service, animation production, movie and television special effects, and digital human hosting. The use scenarios are not specifically limited in the embodiments of this disclosure.

A procedure of the method for generating a motion of a virtual character in the embodiments of this disclosure is described below.

FIG. 2 is a flowchart of a method for generating a motion of a virtual character according to an embodiment of this disclosure. Referring to FIG. 2, this embodiment is performed by a computer device. An example in which the computer device is a server is used for description. The server may be the server 102 in the foregoing implementation environment. This embodiment includes the following operations:

201: The server obtains audio and text of a virtual character, the text indicating semantic information of the audio.

The virtual character is an object movable in a virtual world. The virtual character is a virtual and personified digital character in the virtual world. For example, the virtual character includes, but is not limited to, a game person, a virtual anchor, a virtual avatar, a movie and television person, an animation person, a digital human, a virtual human, or the like. The virtual character is not specifically limited in the embodiments of this disclosure.

In this embodiment of this disclosure, when the virtual character needs to be controlled to broadcast audio, the virtual character further needs to be controlled to perform a motion matching the audio. Therefore, the server generates a motion sequence of the virtual character.

The audio includes at least one audio frame, the text is the text indicating the semantic information of the audio, the text includes at least one token, and each token includes at least one character. The audio and the text have an association relationship. To be specific, the text is semantic information obtained by performing ASR recognition on the audio, or the audio is a speech signal sent by broadcasting the text. The speech signal may be a synthesized signal outputted by a machine, or may be a human voice signal acquired by a microphone. A type of the speech signal is not specifically limited herein.

In some embodiments, the server finds, from a local database, a pair of audio and text that have an association relationship. Alternatively, the server extracts a piece of audio from the local database, and performs ASR recognition on the audio, to obtain text indicating semantic information of the audio. Alternatively, the server extracts a piece of text from the local database, and performs sound synthesis on the text, to obtain audio dubbed for the text.

In some other embodiments, the server downloads a pair of audio and text that have an association relationship from a cloud database. Alternatively, the server downloads a piece of audio from the cloud database, and performs ASR recognition on the audio, to obtain text indicating semantic information of the audio. Alternatively, the server downloads a piece of text from the cloud database, and performs sound synthesis on the text, to obtain audio dubbed for the text.

In still other embodiments, the server receives a pair of audio and text that are uploaded by a terminal and that have an association relationship. For example, the terminal sends a motion generation request to the server, and the server receives and parses the motion generation request to obtain the audio and the text. Alternatively, the server receives audio uploaded by the terminal, and performs ASR recognition on the audio, to obtain text indicating semantic information of the audio. For example, the terminal sends a motion generation request to the server, and the server receives and parses the motion generation request to obtain the audio, and performs ASR recognition on the audio to obtain the text indicating the semantic information of the audio. Alternatively, the server receives text uploaded by the terminal, and performs sound synthesis on the text, to obtain audio dubbed for the text. For example, the terminal sends a motion generation request to the server, and the server receives and parses the motion generation request to obtain the text, and performs sound synthesis on the text to obtain the audio dubbed for the text.

In the foregoing processes, because text and audio may be converted into each other, a user may give only audio, or only text, or both audio and text. In addition to specifying by the user, audio and text may also be read from the local database or downloaded from the cloud database. Sources of the audio and the text are not specifically limited in the embodiments of this disclosure.

After obtaining the audio and the text, the server performs the method provided in this embodiment of this disclosure to generate a motion sequence. If the motion sequence matches the semantic information of the text, in a subsequent process of controlling the virtual character to broadcast the audio, the virtual object is controlled to perform body motions indicated by the motion sequence, so that semantic information of the body motions performed by the virtual object matches the broadcasted audio.

202: The server determines a semantic tag of the text based on the text, the semantic tag representing part-of-speech information of a token in the text or sentiment information expressed by the text.

In some embodiments, the server analyzes the text obtained in operation 201, to obtain at least one semantic tag of the text. The semantic tag may include at least one of a part-of-speech tag or a sentiment tag. The part-of-speech tag represents part-of-speech information of a token in the text. The part-of-speech information of the token is information configured for describing a part of speech of the token, such as a subject, a verb, or a state. The sentiment tag represents sentiment information expressed by the text. The sentiment information is information configured for describing sentiment expressed by the text, such as happiness, disappointment, or anger. Both the part-of-speech information and the sentiment information describe the text, but have different description angles. Content of the semantic tag is not specifically limited in the embodiments of this disclosure. There may be one or more semantic tags. The quantity of semantic tags is not specifically limited in the embodiments of this disclosure.

In some embodiments, the server determines, based on the text, at least one token included in the text; determines, for each token, a part-of-speech tag of the token; and uses part-of-speech tags of all tokens in the text as the semantic tag of the text. A manner of extracting the part-of-speech tag is described in detail in a next embodiment. Details are not described herein again.

In some other embodiments, the server determines at least one sentiment tag of the text based on the text, and uses the at least one sentiment tag as the semantic tag of the text. A manner of extracting the sentiment tag is described in detail in a next embodiment. Details are not described herein again.

In still other embodiments, the server determines a part-of-speech tag of each token based on the text, determines each sentiment tag of the text based on the text, and then uses each part-of-speech tag and each sentiment tag together as the semantic tag of the text.

In an example, tokenization is performed on text “I first live-stream!”, to obtain a token list {“I”, “first”, “live live-stream!”}. It is found in a part-of-speech table that, a part-of-speech tag of the token “I” is a “subject”, a part-of-speech tag of the token “first” is a “state”, and a part-of-speech tag of the token “live-stream!” is a “verb”. In addition, a sentiment tag “happy” of the text is determined based on the text. In this case, four semantic tags: “subject”, “state”, “verb”, and “happy” are finally outputted.

In the foregoing processes, by analyzing given text, feature information of the text at a semantic level can be extracted, and the feature information is represented in a brief manner such as a semantic tag. This facilitates using the semantic tag at the semantic level as a guide signal during motion generation, thereby facilitating synthesis of a virtual character body motion that highly matches semantics of audio and that is smooth and natural.

203: The server retrieves a motion category matching the semantic tag and motion data belonging to the motion category from a preset motion library, the preset motion library including motion data of the virtual character belonging to a plurality of motion categories.

In some embodiments, for each semantic tag obtained in operation 202, a motion category matching the semantic tag is retrieved from a plurality of candidate categories in the preset motion library by using the semantic tag as an index. The preset motion library is a motion database created and maintained by the server side, and is configured to store a motion set of each motion category by using a motion category as a unit. Each motion set includes motion data clustered to the motion category. A method for creating the preset motion library is described in detail in subsequent embodiments. Details are not described herein again.

However, in a possible implementation case, not a matched motion category can be found for each semantic tag. If a semantic tag does not match all candidate categories, a preset motion category may be used as a motion category matching the semantic tag, to avoid a vacancy for a period of time in the motion sequence. The preset motion category may be a default motion category preconfigured by a technical person, for example, a standing motion category or a sitting motion category without semantics. The preset motion category is not specifically limited herein, and the technical person may configure different preset motion categories for different virtual characters.

In the foregoing processes, a motion category most matching audio at a semantic level can be retrieved from the preset motion library by using a semantic tag of text as an index. The motion category does not simply make a rhythm with an audio tempo, but can highly match semantic information of the audio, and can reflect a sentimental tendency and latent semantics of a virtual character during audio broadcasting. In this way, a more accurate motion sequence can be synthesized for the virtual character by using motion data selected from the motion category.

After the motion category matching the audio is retrieved, motion data belonging to the motion category is retrieved from the preset motion library, where the motion data may be configured for controlling the virtual character to present a particular motion.

204: The server generates a motion sequence of the virtual character based on the motion data, the motion sequence being configured for controlling the virtual character to perform motions matching the audio.

In some embodiments, after a motion category is configured for each semantic tag, for each semantic tag, motion data belonging to the motion category may be retrieved from the preset motion library. For example, the motion data may include a plurality of frames of 3D skeleton data at consecutive moments (in other words, each frame of 3D skeleton data may be referred to as a motion frame), and each frame of 3D skeleton data includes at least pose data of each skeleton key point in a motion picture presented in the frame. In this way, the virtual character can be controlled to present a particular motion provided that each frame of 3D skeleton data is migrated to a 3D skeleton model of the virtual character. Then, the motion data matching each semantic tag may be spliced according to a timestamp order of a token corresponding to each semantic tag in the audio, to form the motion sequence of the virtual character. The motion sequence represents body motion changes of the virtual character at consecutive moments during audio broadcasting, and is configured for controlling the virtual character to perform body motions matching the audio during the audio broadcasting.

In some embodiments, according to a phone alignment tool, a timestamp interval corresponding to each semantic tag can be found in an audio timeline. The timestamp interval is a time period in which the virtual character broadcasts the token belonging to the semantic tag. Then, the motion data matching the semantic tag is retrieved from a motion set of the motion category in the preset motion library, and the motion data is used to fill the timestamp interval in the motion sequence. Motion data in timestamp intervals connected head to tail form the motion sequence of the virtual character at consecutive moments. Both a phone alignment manner and a motion data query manner are described in detail in a next embodiment. Details are not described herein again.

In the foregoing processes, each motion frame in the finally synthesized motion sequence is aligned with a timestamp of one audio frame in the audio, so that the motion frame reflects a body motion matching the audio frame at the semantic level. In this way, the sound-picture matching degree and accuracy are greatly improved, and a mechanical and rigid visual effect is not generated, so that the simulation degree and the personification degree of the virtual character can be improved, and a rendering effect of the virtual character can be optimized.

A device and an occasion of controlling the virtual character to broadcast the audio and perform the motion matching the audio are not limited in the embodiments of this disclosure. In some embodiments, the server controls the virtual character to broadcast the audio and perform the motions matching the audio based on the motion sequence. In some other embodiments, the server sends the generated motion sequence to an associated terminal, and the terminal controls the virtual character to broadcast the audio and perform the motions matching the audio based on the motion sequence. In addition, after generating the motion sequence, the server may immediately control the virtual character to broadcast the audio and perform the motions matching the audio based on the motion sequence; or first stores the motion sequence and the audio or the text in an associated manner, and subsequently controls, when receiving a broadcast instruction, the virtual character to broadcast the audio and perform the motions matching the audio based on the motion sequence.

All the foregoing exemplary technical solutions can be arbitrarily combined to form an exemplary embodiment of the present disclosure. Details are not described herein again.

According to the method provided in this embodiment of this disclosure, by using audio and text as dual-modality driving signals, a semantic tag at a semantic level is extracted based on the text, to facilitate retrieval of a motion category matching the semantic tag from a preset motion library. The motion category can highly match semantic information of the audio, and can reflect a sentimental tendency and latent semantics of a virtual character during audio broadcasting. Then, motion data belonging to the motion category is retrieved, and a more accurate motion sequence is rapidly and efficiently synthesized for the virtual character based on the motion data, thereby improving motion generation efficiency of the virtual character and improving motion generation accuracy.

Further, the motion sequence can be configured for controlling the virtual character to perform body motions matching the audio at the semantic level, instead of simply making a rhythm with an audio tempo. In this way, the sound-picture matching degree and accuracy are greatly improved, and a mechanical and rigid visual effect is not generated, so that the simulation degree and the personification degree of the virtual character can be improved, and a rendering effect of the virtual character can be optimized.

In the foregoing embodiments, the procedure of the method for generating a motion of a virtual character is briefly described, and the audio-and-text-triggered body motion generation framework is provided. Because a virtual character sounds audio and performs body motions during text broadcasting, a latent mapping relationship exists among the audio, text, and the body motions, and the audio, the text, and the body motions can be aligned in an audio timeline. In this embodiment of this disclosure, the mapping relationship is mined. After the audio and the text thereof are obtained, a motion category matching the audio at a semantic level is retrieved from a preset motion library by using a semantic tag of the text, and then a motion sequence of the virtual character is synthesized according to motion data belonging to the motion category. The foregoing motion generation solution may be applicable to a body motion generation scenario of any virtual character, for example, a game person, a virtual anchor, a movie and television person, or an animation person.

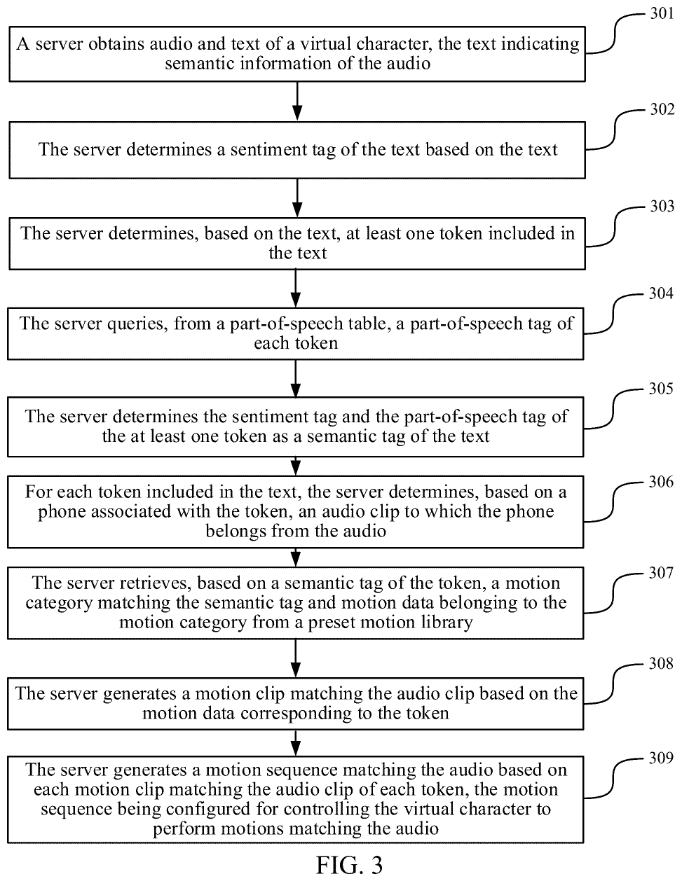

In this embodiment, a specific implementation of each operation in the method for generating a motion of a virtual character is described in detail. FIG. 3 is a flowchart of a method for generating a motion of a virtual character according to an embodiment of this disclosure. Referring to FIG. 3, this embodiment is performed by a computer device. An example in which the computer device is a server is used for description. The server may be the server 102 in the foregoing implementation environment. This embodiment includes the following operations:

301: The server obtains audio and text of a virtual character, the text indicating semantic information of the audio.

The audio includes at least one audio frame, the text is the text indicating the semantic information of the audio, the text includes at least one token, and each token includes at least one character. The audio and the text have an association relationship. To be specific, the text is semantic information obtained by performing ASR recognition on the audio, or the audio is a speech signal sent by broadcasting the text. The speech signal may be a synthesized signal outputted by a machine, or may be a human voice signal acquired by a microphone. A type of the speech signal is not specifically limited herein.

In some embodiments, the server finds, from a local database, a pair of audio and text that have an association relationship. Alternatively, the server extracts a piece of audio from the local database, and performs ASR recognition on the audio, to obtain text indicating semantic information of the audio. Alternatively, the server extracts a piece of text from the local database, and performs sound synthesis on the text, to obtain audio dubbed for the text.

In some other embodiments, the server downloads a pair of audio and text that have an association relationship from a cloud database. Alternatively, the server downloads a piece of audio from the cloud database, and performs ASR recognition on the audio, to obtain text indicating semantic information of the audio. Alternatively, the server downloads a piece of text from the cloud database, and performs sound synthesis on the text, to obtain audio dubbed for the text.

In still other embodiments, the server receives a pair of audio and text that are uploaded by a terminal and that have an association relationship. For example, the terminal sends a motion generation request to the server, and the server receives and parses the motion generation request to obtain the audio and the text. Alternatively, the server receives audio uploaded by the terminal, and performs ASR recognition on the audio, to obtain text indicating semantic information of the audio. For example, the terminal sends a motion generation request to the server, and the server receives and parses the motion generation request to obtain the audio, and performs ASR recognition on the audio to obtain the text indicating the semantic information of the audio. Alternatively, the server receives text uploaded by the terminal, and performs sound synthesis on the text, to obtain audio dubbed for the text. For example, the terminal sends a motion generation request to the server, and the server receives and parses the motion generation request to obtain the text, and performs sound synthesis on the text to obtain the audio dubbed for the text.

In the foregoing processes, because text and audio may be converted into each other, a user may give only audio, or only text, or both audio and text. In addition to specifying by the user, audio and text may also be read from the local database or downloaded from the cloud database. Sources of the audio and the text are not specifically limited in the embodiments of this disclosure.

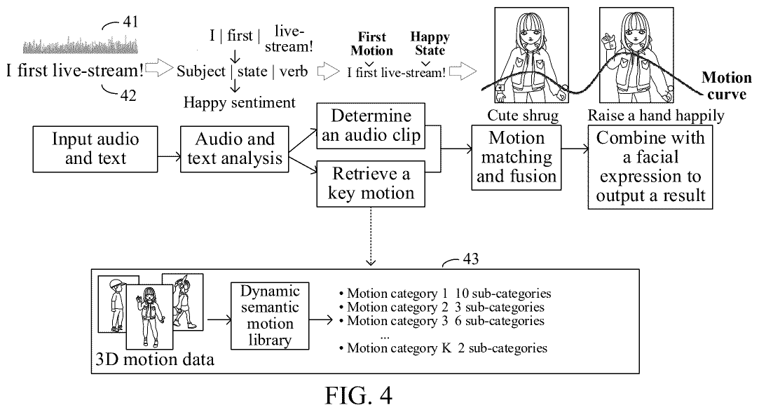

In an exemplary scenario, FIG. 4 is a principle diagram of a method for generating a motion of a virtual character according to an embodiment of this disclosure. A user inputs audio and text on a terminal side, the terminal uploads the inputted audio and text to the server, and the server obtains audio 41 and text 42 “I first live-stream!”. The audio 41 is an audio file that a virtual character broadcasts the text 42. The audio 41 may be an audio file in any form, such as a WAV file, an MP3 file, or an MP4 file.

After obtaining the audio and the text, the server performs the method provided in this embodiment of this disclosure to generate a motion sequence. If the motion sequence matches the semantic information of the text, in a subsequent process of controlling the virtual character to broadcast the audio, the virtual object is controlled to perform body motions indicated by the motion sequence, so that semantic information of the body motions performed by the virtual object matches the broadcasted audio.

302: The server determines a sentiment tag of the text based on the text.

The sentiment tag represents sentiment information expressed by the text, for example, happiness, disappointment, or anger. Content of the sentiment tag is not specifically limited in the embodiments of this disclosure.

In some embodiments, the server pre-stores a plurality of candidate sentiment tags, configures a plurality of sentiment keywords for each candidate sentiment tag, and stores a mapping relationship between a sentiment keyword and a sentiment tag, to provide a sentiment analysis method based on keyword matching. If the text includes any sentiment keyword, a sentiment tag to which the sentiment keyword is mapped may be found based on the mapping relationship, and the found sentiment tag is used as a sentiment tag of the text. Certainly, if the text includes a plurality of sentiment keywords, a sentiment tag to which each sentiment keyword is mapped is used as the sentiment tag of the text. If the plurality of sentiment keywords are mapped to a same sentiment tag, deduplication further needs to be performed on the sentiment tag of the text.

In the foregoing sentiment analysis manner based on keyword matching, the calculation amount is small, the calculation complexity is low, and the sentiment analysis has a high speed and high efficiency.

In some other embodiments, the server pre-stores a plurality of candidate sentiment tags, and configures one sentiment feature for each candidate sentiment tag; and then extracts a text feature for the entire text, calculates a feature similarity between the text feature and the sentiment feature of each candidate sentiment tag, and uses a sentiment tag having a highest feature similarity as the sentiment tag of the text.

Further, considering that sometimes text needs to be flat and have no sentiment tendency during text broadcasting, a technical person may further preconfigure a feature similarity threshold. If feature similarities of all candidate sentiment tags are less than the feature similarity threshold, in this case, the sentiment tag having the highest feature similarity is not selected. In this case, the sentiment tag is vacant, or a default sentiment tag “no sentiment” is used as the sentiment tag of the text. In this way, accuracy of recognizing the sentiment tag can be improved, and it can be ensured that an inappropriate sentiment tag is not added to text without sentiment.

Further, considering that sometimes sentiment compositions are complex during text broadcasting and a plurality of sentiments may coexist, when a feature similarity threshold is preconfigured, a sentiment tag whose feature similarity is greater than the feature similarity threshold may alternatively be used as the sentiment tag of the text. In this way, the accuracy of recognizing the sentiment tag can be further improved, and text intermixed with a plurality of sentiments has a better performance capability.

A quantity of sentiment tags determined by using the foregoing sentiment analysis manner based on a feature similarity may be 0, 1, or more than 1, and the quantity of sentiment tags is not specifically limited herein. A sentiment tendency of the entire text is judged according to a similarity in a feature space. In this way, compared with the keyword matching manner, the accuracy of sentiment analysis is higher. This is because some pieces of text may not include any sentiment keyword, but the entire text expresses an apparent sentiment tendency at a semantic level. This case can be detected by comparing feature similarities.

In still other embodiments, the server pre-trains a sentiment analysis model, and inputs the text to the sentiment analysis model. The sentiment analysis model calculates a matching probability between the text and each candidate sentiment tag, and then outputs one or more sentiment tags matching the text based on the matching probability between the text and each candidate sentiment tag. In this case, a sentiment tag “no sentiment” needs to be added to the candidate sentiment tags, to cover recognition accuracy in a case of no sentiment. Similarly, the technical person may alternatively preconfigure a probability threshold, so that a sentiment tag having a highest matching probability may be selected to be outputted. The probability threshold is a value greater than or equal to 0 and less than or equal to 1. Alternatively, all sentiment tags whose matching probabilities are greater than the probability threshold are outputted. Alternatively, top N (N≥1) sentiment tags in descending order of matching probabilities are outputted. This is not specifically limited in the embodiments of this disclosure. In some embodiments, the sentiment analysis model may be a classification model, a decision tree, a deep neural network, a convolutional neural network, a multilayer perceptron, or the like. This is not specifically limited in the embodiments of this disclosure.

In the foregoing sentiment analysis manner based on a sentiment analysis model, a latent mapping relationship between the text and the sentiment tag is learned by using a machine learning method, to judge the matching probability between the text and each candidate sentiment tag, so that sentiment analysis accuracy can be improved. The sentiment analysis manner is not specifically limited in the embodiments of this disclosure.

Operation 302 is an exemplary operation. If a sentiment tag is not considered in a semantic tag, sentiment analysis does not need to be performed on the text. Whether sentiment analysis needs to be performed on the text is not specifically limited in the embodiments of this disclosure.

In an exemplary scenario, FIG. 4 is still used as an example for description. By using any one of the foregoing sentiment analysis manners, sentiment analysis is performed on the text 42 “I first live-stream!”, to obtain a sentiment tag “happy” of the text 42, which indicates that the virtual character needs to be immersed in the happy sentiment when broadcasting the text 42.

303: The server determines, based on the text, at least one token included in the text.

In some embodiments, the server performs tokenization on the text, to obtain a token list of the text. The token list is configured for recording the at least one token included in the text, and each token includes at least one character.

The tokenization process may be implemented by using a tokenization tool. According to different languages of text, different tokenization tools may be used. For example, for Chinese text, tokenization is performed by using a Chinese tokenization tool, to obtain a token list of the Chinese text. For another example, for English text, tokenization is performed by using an English tokenization tool, to obtain a token list of the English text. A language of the text is not specifically limited in the embodiments of this disclosure, and a type of the tokenization tool is not specifically limited.

In an exemplary scenario, FIG. 4 is still used as an example for description. Tokenization is performed on text 42 “I first live-stream!”, to obtain a token list {“I”, “first”, “live live-stream!”}. The text 42 includes three tokens, the first token “I” includes one character, the second token “first” includes three characters, and the third token “live-stream!” includes three characters.

304: The server queries, from a part-of-speech table, a part-of-speech tag of each token.

The part-of-speech tag represents part-of-speech information of the token in the text, for example, a subject, a verb, or a state. Content of the part-of-speech tag is not specifically limited in the embodiments of this disclosure.

In some embodiments, the server pre-stores a part-of-speech table, where the part-of-speech table records candidate part-of-speech tags; and then performs querying in the part-of-speech table for each token obtained through tokenization on the text, to calculate a vector similarity between a token vector of the token and a tag vector of each part-of-speech tag, and use a part-of-speech tag having a highest vector similarity as the part-of-speech tag of the token.

In an exemplary scenario, FIG. 4 is still used as an example for description. Tokenization is performed on the text 42 “I first live-stream!”, to obtain the token list {“I”, “first”, “live live-stream!”}. Then, it is found in the part-of-speech table that, a part-of-speech tag of the first token “I” is a “subject”, a part-of-speech tag of the second token “first” is a “state”, and a part-of-speech tag of the third token “live-stream!” is a “verb”.

In the foregoing operation 303 and operation 304, a possible implementation of extracting the part-of-speech tag of each token in the text is provided. In the part-of-speech table querying manner, the calculation amount is small, the calculation complexity is low, and the part-of-speech analysis has a high speed and high efficiency. Certainly, a part-of-speech analysis model may also be trained, and the text is inputted to the part-of-speech analysis model. The part-of-speech analysis model outputs a series of tokens and part-of-speech tags of the tokens. In this way, accuracy of part-of-speech analysis is high. The part-of-speech analysis manner specifically limited in the embodiments of this disclosure.

In the foregoing part-of-speech analysis process, because different body motions are usually made for tokens of different parts of speech during speaking, different parts of speech also affect categories or amplitudes of body motions. Considering the part-of-speech tag of each token can better reflect implicit information of the text at the semantic level.

Operation 304 is an exemplary operation. If a part-of-speech tag is not considered in a semantic tag, part-of-speech analysis does not need to be performed on the text (however, tokenization needs to be performed because tokens, phones, and motions can be aligned only after tokenization). Whether part-of-speech analysis needs to be performed on the text is not specifically limited in the embodiments of this disclosure.

305: The server determines the sentiment tag and the part-of-speech tag of the at least one token as a semantic tag of the text.

The semantic tag represents the part-of-speech information of the token in the text or the sentiment information expressed by the text.

In some embodiments, the sentiment tag obtained in operation 302 and the part-of-speech tag obtained in operation 304 are determined as semantic tags of the text. There may be one or more semantic tags. The quantity of semantic tags is not specifically limited in the embodiments of this disclosure.

In an exemplary scenario, FIG. 4 is still used as an example for description. Tokenization is performed on the text 42 “I first live-stream!”, to obtain the token list {“I”, “first”, “live live-stream!”}. It is found in the part-of-speech table that, the part-of-speech tag of the first token “I” is a “subject”, the part-of-speech tag of the second token “first” is a “state”, and the part-of-speech tag of the third token “live-stream!” is a “verb”. In addition, sentiment analysis is performed on the text 42, to obtain the sentiment tag “happy” of the text 42. In this case, four semantic tags: “subject”, “state”, “verb”, and “happy” are finally outputted. The foregoing process of analyzing the text 42 and extracting the semantic tag is referred to as an “audio and text analysis” process.

In operation 302 to operation 305, a possible implementation in which the server determines the semantic tag of the text is described by using an example in which both the part-of-speech tag and the sentiment tag are considered in the semantic tag. By analyzing given text, feature information of the text at a semantic level can be extracted, and the feature information is represented in a brief manner such as a semantic tag. This facilitates using the semantic tag at the semantic level as a guide signal during motion generation, thereby facilitating synthesis of a virtual character body motion that highly matches semantics and that is smooth and natural.

The semantic tag may include at least one of the part-of-speech tag or the sentiment tag. If the part-of-speech tag is not considered in the semantic tag, operation 304 does not need to be performed. If the sentiment tag is not considered in the semantic tag, operation 302 does not need to be performed. Content of the semantic tag is not specifically limited in the embodiments of this disclosure.

306: For each token included in the text, the server determines, based on a phone associated with the token, an audio clip to which the phone belongs from the audio.

In some embodiments, for each token included in the text in operation 303, a phone associated with the token may be determined. The phone associated with the token is a phone that needs to be sounded for broadcasting the token. Each token may be associated with one or more phones. The quantity of phones is not specifically limited in the embodiments of this disclosure. Then, at least one audio frame corresponding to the phone is found from the audio, and the at least one audio frame forms the audio clip to which the phone belongs. In this way, an audio clip can be found for each token from the audio in a phone alignment manner, so that the token is aligned with the audio clip in an audio timeline.

In an exemplary scenario, FIG. 4 is still used as an example for description. After each token in the text 42 is obtained through tokenization in operation 303, phone alignment may be performed. To be specific, N (N≥1) phones for broadcasting the token are determined, at least one audio frame (for example, a second frame to a 37^{th} frame) in which the N phones are sounded is found in the audio 41, and the at least one audio frame is used as an audio clip to which the token is aligned. The foregoing process may be considered as a process of determining an audio clip aligned with each token of the text 42 from the audio.

Operation 306 can be performed after tokenization is completed in operation 303, and may be performed in parallel or in series with extraction of the sentiment tag in operation 302 and extraction of the part-of-speech tag in operation 304. A sequence of performing operation 302, operation 304, and operation 306 is not limited in the embodiments of this disclosure.

307: The server retrieves, based on a semantic tag of the token, a motion category matching the semantic tag and motion data belonging to the motion category from a preset motion library.

The preset motion library includes motion data of the virtual character belonging to a plurality of motion categories.

In some embodiments, each semantic tag obtained in operation 305 is associated with one token in the text. For the part-of-speech tag in the semantic tag, the part-of-speech tag is obtained by performing querying in the part-of-speech table by using a token as a unit. Therefore, there is a natural association relationship between the part-of-speech tag and the token. Each token certainly belongs to one part-of-speech tag, but different tokens may have a same part-of-speech tag. However, for the sentiment tag in the semantic tag, because sentiment analysis is performed on the entire text, a sentiment tendency of the text can be better determined in combination with the context of the entire text, but a token most matching the sentiment tag also needs to be found in the text. For example, if the sentiment tag is determined by using the sentiment analysis manner based on keyword matching, a matched sentiment keyword (which is certainly a token in the text) is directly used as the token most matching the sentiment tag. If the sentiment analysis manner based on a feature similarity or the sentiment analysis model is used, when the sentiment tag and each token obtained through tokenization are known, in turn, a vector similarity between a token vector of the sentiment tag and a token vector of each token is calculated, and a token having a highest vector similarity is used as the token most matching the sentiment tag.

In the foregoing manner, regardless of whether a semantic tag covers a part-of-speech tag or a sentiment tag, a most matched token can be found for each semantic tag. A same token may have one or more semantic tags. For example, FIG. 4 is still used as an example for description. In text 42 “I first live-stream!”, the token “live-stream!” has two semantic tags, where one semantic tag is a part-of-speech tag “verb”, and the other semantic tag is a sentiment tag “happy”. A quantity and types of semantic tags of each token are not specifically limited in the embodiments of this disclosure.

In this way, for each token in the text, after one or more semantic tags of the token are determined, by using each semantic tag of the token as an index, a motion category matching the semantic tag is queried from a plurality of candidate categories in the preset motion library, so that motion data belonging to the motion category can be queried.

A possible implementation of querying a motion category based on a semantic tag is described below by using operation A1 to operation A4 as an example. In this implementation, it is judged whether the semantic tag is similar to a candidate category from the feature space.

A1: The server extracts a semantic feature of the semantic tag.

In some embodiments, for each semantic tag of each token in the text, the server extracts the semantic feature of the semantic tag, for example, directly uses a token vector of the semantic tag as the semantic feature. Alternatively, the server pre-trains a feature extraction model, and inputs the semantic tag to the feature extraction model; and the feature extraction model processes the semantic tag, and outputs the semantic feature of the semantic tag. The feature extraction model may be any NLP model. More further, to improve feature extraction efficiency, semantic features of all candidate part-of-speech tags and all candidate sentiment tags may be pre-extracted, and each part-of-speech tag or sentiment tag is stored in association with the semantic feature thereof. In this way, for each semantic tag, the semantic feature stored in association with a tag identifier (ID) is directly and rapidly found according to the tag ID of the semantic tag. This is equivalent to that the semantic feature of each semantic tag is calculated offline, so that only a small number of query overheads need to be cost at an online motion generation stage, and the semantic feature does not need to be calculated in real time, so that feature extraction efficiency can be improved.

In some embodiments, a tag ID and a semantic feature thereof are stored by using a Key-Value (key-value pair) data structure, where the tag ID is a Key (key name), and the semantic feature is a Value (key value). At an online query stage, whether any Key-Value data structure can be hit is queried by using the tag ID as an index. If a Key-Value data structure can be hit, a semantic feature stored in a Value is extracted, and the semantic feature is a semantic feature of a semantic tag indicated by the tag ID.

A2: The server queries category features of the plurality of candidate categories in the preset motion library.

In some embodiments, the server creates and maintains the preset motion library. The preset motion library includes the motion data of the virtual character belonging to the plurality of motion categories. A process of constructing the motion library is described in detail in a next embodiment. Details are not described herein again. A large amount of motion data is stored in the preset motion library. For ease of retrieval, the motion data is clustered at a semantic level, so that the motion data is divided into a plurality of motion categories. A motion set exists under each motion category, and the motion set stores motion data clustered to the corresponding motion category. In some embodiments, the motion data may be implemented as a plurality of frames of 3D skeleton data of the virtual character at consecutive moments when motions of the motion category are performed.

Further, all the motion categories in the preset motion library form a plurality of candidate categories of the current semantic tag. In this case, the server may calculate a category feature of each candidate category. For example, the server uses a token vector of the candidate category as the category feature of the candidate category. For another example, the server reuses the feature extraction model used in operation A1, and inputs the candidate category to the feature extraction model; and the feature extraction model processes the candidate category, and outputs the category feature of the candidate category. Only reusing the feature extraction model in operation A1 is used as an example herein for description, so that training overheads on a server side can be reduced, a feature extraction model does not need to be trained again, and the semantic tag and the motion category can be projected to a same feature space. Certainly, the server side may alternatively train a semantic feature extraction model for the semantic tag and train a category feature extraction model for the motion category, so that extraction processes of the semantic feature and the category feature are more targeted, thereby improving expression capabilities of the semantic feature and the category feature. This is not specifically limited in the embodiments of this disclosure.

More further, to improve the feature extraction efficiency, category features of all the motion categories (that is, all the candidate categories) in the preset motion library may be pre-extracted by using the completely trained feature extraction model, and then each motion category is stored in association with the category feature of the motion category. In this way, at the online motion generation stage, for each candidate category, a category feature stored in association with a category ID is directly and rapidly queried according to the category ID of the candidate category. This is equivalent to that the category feature of each candidate category is calculated offline, so that only a small number of query overheads need to be cost during online querying, and the category feature does not need to be calculated in real time, so that the feature extraction efficiency can be improved.

In some embodiments, a category ID and a category feature thereof are stored by using a Key-Value data structure, where the category ID is a Key, and the category feature is a Value. At the online query stage, whether any Key-Value data structure can be hit is queried by using the category ID as an index. If a Key-Value data structure can be hit, a category feature stored in a Value is extracted, and the category feature is a category feature of a candidate category indicated by the tag ID.

In this embodiment of this disclosure, to distinguish the motion category matching the semantic tag from motion categories used as candidates, the candidate categories and the motion category are distinguished. In other words, the candidate categories and the motion category are relative to the semantic tag. However, for the preset motion library, all categories are motion categories supported by the preset motion library, and there is no concept of the candidate category.

A3: The server determines the motion category from the plurality of candidate categories, the category feature of the motion category and the semantic feature meeting a similarity condition.

The similarity condition represents whether the semantic tag is similar to the candidate category.

In some embodiments, for each semantic tag of each token in the text, the server obtains the semantic feature of the semantic tag in operation A1, and obtains the category features of all the candidate categories in the preset motion library in operation A2. Then, a feature similarity between the semantic feature and the category feature of each candidate category is calculated, and a candidate category whose feature similarity meets the similarity condition is selected from the plurality of candidate categories as the motion category matching the semantic tag. In other words, the category feature of the determined motion category and the semantic feature meet the similarity condition. The feature similarity may be a cosine similarity, a reciprocal of a Euclidean distance, or the like. This is not specifically limited in the embodiments of this disclosure.

In some embodiments, the similarity condition is that a feature similarity is the highest. In this case, only a candidate category having the highest feature similarity needs to be found from all the candidate categories as the motion category matching the semantic tag. In this way, it can be ensured that a motion category most similar at the semantic level can be found for each semantic tag, and there is no case in which some semantic tags have no matched motion categories. The motion category filtering procedure is simple, and the calculation efficiency is high.

In some other embodiments, the similarity condition is that a feature similarity is greater than a preset similarity threshold, where the preset similarity threshold is a value that is greater than 0 and that is predefined by a technical person. If there is only one candidate category meeting the similarity condition, the only one candidate category is used as the motion category matching the semantic tag. If there are more than one candidate category meeting the similarity condition, a candidate category having a highest feature similarity is selected as the motion category matching the semantic tag. If there are 0 candidate categories meeting the similarity condition, that is, none of all the candidate categories meets the similarity condition, operation A4 is entered. In this way, by configuring a preset similarity threshold, some cases in which some sentiments are stable and do not include particular apparent semantics during broadcasting can be considered. In this case, the virtual character calmly broadcasts content, and does not need to make a body motion with particular semantics (which may be exaggerated if made). In this case, an overall value of each feature similarity is actually low. If the preset similarity threshold is not configured, a feature similarity having a maximum relative value is directly selected. If the preset similarity threshold is configured, a policy that all the candidate categories do not match is provided. In this case, operation A4 is entered: The motion category matching the semantic tag is directly configured as a preset motion category having no special semantics, for example, a standing motion category, or a sitting motion category.

In the foregoing operation A1 to operation A3, an implementation of judging, from the feature space, whether a semantic tag is similar to a candidate category is provided. In this way, for any semantic tag, a motion category that meets a similarity condition with the semantic tag in the feature space can be found. Whether the preset motion category is used to fill the semantic tag not similar to all the candidate categories can be flexibly controlled by controlling the similarity condition, thereby improving motion category recognition efficiency and improving motion category controllability.

A4: The server configures the motion category matching the semantic tag as the preset motion category when the category features of the plurality of candidate categories and the semantic feature do not meet the similarity condition.

In some embodiments, according to the similarity condition, not a matched motion category can be found for each semantic tag. If the semantic feature of the semantic tag and the category features of all the candidate categories do not meet the similarity condition, it indicates that the semantic tag does not match all the candidate categories, and the preset motion category may be used as the motion category matching the semantic tag, to avoid a vacancy for a period of time in the motion sequence. The preset motion category may be a default motion category preconfigured by the technical person, for example, a standing motion category or a sitting motion category without semantics. The preset motion category is not specifically limited herein, and the technical person may configure different preset motion categories for different virtual characters.

In the foregoing operation A1 to operation A4, a possible implementation of selecting a motion category of each semantic tag by using a semantic tag as a unit is provided. A motion category most matching audio at a semantic level can be found from the preset motion library by using a semantic tag of text as an index. The motion category does not simply make a rhythm with an audio tempo, but can highly match semantic information of the audio, and can reflect a sentimental tendency and latent semantics of a virtual character during audio broadcasting. In this way, a more accurate motion sequence can be synthesized for the virtual character by using motion data selected from the motion category.

In some other embodiments, in addition to operation A1 to operation A4, a motion classification model may also be trained, and each semantic tag is inputted to the motion classification model. The motion classification model predicts a matching probability between the semantic tag and each candidate category, and outputs a motion category having a highest matching probability. In this way, the scenario in which a body motion including semantics does not need to be made during broadcasting can be covered provided that the foregoing preset motion category is added to the candidate categories, so that the accuracy of recognizing the motion category can be further improved.

Each semantic tag is associated with one token, but each token may have a plurality of semantic tags. Therefore, to make tokens and motion categories be in a one-to-one correspondence, for a token having a plurality of semantic tags, a plurality of matched motion categories may exist. In this case, after a motion category matching each semantic tag is found, a motion category matching all the semantic tags of the token is preferentially selected as a motion category finally selected for the token. If no motion category matching all the semantic tags of the token exists, a motion category having a higher feature similarity is preferentially selected, or the preset motion category is directly configured. For example, it is assumed that a token has two semantic tags a and b, the semantic tag a matches motion categories 1 and 2, and the semantic tag b matches motion categories 1 and 3. In this case, the motion category 1 is directly selected as a final motion category of the token. However, if the semantic tag b matches motion categories 3 and 4, a motion category having a highest feature similarity is selected from the motion categories 1 to 4, or a preset motion category is directly selected as the final motion category of the token.

In an exemplary scenario, FIG. 4 is still used as an example. By using each semantic tag obtained at the audio and text analysis stage as an index, a motion category matching the semantic tag is selected from K (K≥2) motion categories in a preset motion library 43. For example, for the three tokens “I”, “first”, and “live-stream!” in the text 42, the first token “I” has only one semantic tag “subject”, a matched motion category is not found for the semantic tag “subject” in the preset motion library 43. Therefore, the motion category matching the first token is configured as a preset motion category “standing”. The second token “first” has only one semantic tag “state”, but a matched motion category “cute shrug” is found for the semantic tag “state” in the preset motion library 43. The third token “live-stream!” has two semantic tags “verb” (the part-of-speech tag) and “happy” (the sentiment tag). The semantic tags “verb” and “happy” jointly lock a motion category “raise a hand happily”, in other words, the motion category “raise a hand happily” matches both the two semantic tags “verb” and “happy”. Therefore, the motion category “raise a hand happily” is selected as a motion category most matching the third token “live-stream!”.

The preset motion library 43 is also referred to as a dynamic semantic preset motion library including massive motion data. The massive motion data may be acquired, disclosed, and compliant data of 3D motion clips of virtual characters. For example, each 3D motion clip includes a plurality of frames of 3D skeleton data at consecutive moments. The foregoing process of retrieving a motion category according to a semantic tag is also referred to as retrieving a key Pose (retrieving a key motion) of each semantic tag.

Further, because a data level of the preset motion library 43 may be very large, each motion category may be further divided into a plurality of sub-categories. For example, a motion category “raise a hand” is further divided into a plurality of sub-categories: “raise one hand”, “raise two hands”, and the like. In an example, as shown in FIG. 4, a motion category 1 includes 10 sub-categories, a motion category 2 includes 3 sub-categories, a motion category 3 includes 6 sub-categories, . . . . By analogy, a motion category K includes 2 sub-categories. Whether each motion category is divided into sub-categories is not specifically limited herein.

For each semantic tag, when each motion category includes sub-categories, a sub-category matching the semantic tag may also be found from all sub-categories of the determined motion categories by calculating feature similarities in a manner similar to operation A1 to operation A3, so that the matching degree between the motion data used in operation 308 and the semantic tag at the semantic level can be further improved.

308: The server generates a motion clip matching the audio clip based on the motion data corresponding to the token.

In operation 307, that a unique corresponding motion category can be found for each token includes the following several cases for summarization: (1) The token has one semantic tag. If the semantic tag has a motion category meeting the similarity condition, the motion category is selected. If the semantic tag does not have a motion category meeting the similarity condition, a preset motion category is selected. (2) The token has a plurality of semantic tags. After a motion category (including the preset motion category) is selected for each semantic tag based on operation (1), if a motion category matching all the semantic tags of the token exists, the motion category matching the token is selected. If a plurality of motion categories matching the token also exist, a motion category matching the token and having a highest feature similarity is selected. If no motion category matching all the semantic tags of the token exists, a motion category matching a largest quantity of semantic tags is selected, or a motion category having a highest feature similarity is selected, or a preset motion category is selected. This is not specifically limited in the embodiments of this disclosure.

Based on the foregoing description, each token has the one-to-one corresponding motion category (including the preset motion category). Therefore, according to the correspondence of the audio timeline, the audio clip can be found for each token in operation 306, and the motion category can be found for each token in operation 307. According to the motion data belonging to the motion category in the preset motion library, the motion clip may be synthesized for the token, thereby ensuring that timestamps of the motion clip and the audio clip are aligned and the motion clip and the audio clip highly match at the semantic level.

A possible motion clip synthesis manner is described below by using operation B1 and operation B2. In the synthesis manner, audio frames and key motion frames can be in a one-to-one correspondence, so that timestamps of the audio frames and the key motion frames are aligned.

B1: The server determines, from the motion data, at least one key motion frame whose semantic matching degree with the token is highest.

In some embodiments, the tokens and the motion categories are in a one-to-one correspondence. Therefore, for each token, the server retrieves the motion data belonging to the motion category corresponding to the token from the preset motion library, to perform filtering on the motion data, to obtain the at least one key motion frame whose semantic matching degree with the token is highest.

In some embodiments, each motion category in the preset motion library stores one motion set, where the motion set is configured for storing motion data belonging to the motion category. For example, the motion set includes a plurality of motion clips, each motion clip includes a plurality of motion frames, and each motion frame indicates a pose of each skeleton key point at a moment in a process in which the virtual character performs a motion under the motion category. Each motion clip has reference audio and reference text labeled for the motion clip. At a database creation stage, timestamp alignment is also performed on tokens in the reference text, phones in the reference audio, and motion frames in the motion clip. Therefore, when a semantic matching degree between a token and a key motion frame is compared, whether reference text of a motion clip in the motion set includes the token may be first queried. If it is found that reference text is hit, at least one key motion frame matching (that is, whose timestamp is aligned with) the token is directly extracted from a motion clip corresponding to the hit reference text. If it is found that no any reference text is hit, a vector similarity between a token vector of the current token and a token vector of each token in each reference text needs to be further calculated, reference text to which an approximate token (which is usually a synonym and/or a near-synonym) having a highest vector similarity belongs is found, and at least one key motion frame matching (that is, whose timestamp is aligned with) the approximate token is extracted from a motion clip corresponding to the found reference text.

In the foregoing processes, a possible implementation of performing filtering on key motion frames from motion data of a motion set is provided. In this way, a repeated token is first detected, and then an approximate token is detected, so that it can be ensured that the approximate token needs to be detected only when no repeated token is found, thereby reducing calculation overheads of the server. In some other embodiments, when an approximate token is detected, the approximate token may not be judged based on a vector similarity. Instead, a synonym and/or a near-synonym is directly obtained for the token from a token list first, and then whether reference text is hit is queried by using the synonym and/or near-synonym as an index. In this way, the synonym and/or the near-synonym needs to be queried only when no repeated token is found, and the effect of reducing calculation overheads can also be achieved.

In still other embodiments, a case is further considered. If each motion category in the preset motion library is further subdivided into a plurality of sub-categories, in an exemplary manner of operation 307, a sub-category matching the token can be found in the plurality of sub-categories of the motion category. In this way, at the key motion frame retrieval stage, only motion data belonging to the selected sub-category needs to be considered, and motion data belonging to an unselected sub-category does not need to be considered. This is equivalent to reducing a range of querying a key motion frame, further improving efficiency of querying the key motion frame. In addition, a key motion frame found in a small range usually matches both a motion category (that is, a large category) and a sub-category (that is, a small category) belonging to the motion category, so that precision of retrieving the key motion frame is also improved, and coordination and cooperation with the token at the semantic level can be better performed.

In some other embodiments, only one standard motion clip is stored for each motion category in the preset motion library. In this case, only at least one key motion frame nearest to a median motion frame needs to be sampled starting from the median motion frame in the middle of the motion clip. In this way, the key motion frame can be aligned with the middle of the pre-stored standard motion clip, and a standard and key motion/pose is usually located in the middle.

B2: The server synthesizes, based on the audio clip, the at least one key motion frame into the motion clip matching the audio clip.

In some embodiments, for each token in the text, after finding the at least one key motion frame based on operation B1, the server may determine a quantity of key motion frames, and further determine a quantity of audio frames of the audio clip aligned with a timestamp of the token in operation 306, to compare the quantity of the audio frames with the quantity of key motion frames. In some embodiments, According to the quantity of audio frames, the key motion frame is played at a multiplication speed with a particular ratio, to ensure that a finally synthesized motion clip has a same length as the audio clip in operation 306 (that is, timestamps are aligned). In this case, the key motion frame does not need to be cropped or modified, and only the playback multiplication speed needs to be adjusted. Therefore, generally, more details of the key motion frame can be reserved, to present a complete pose change of a key motion matched by the token as much as possible.

In some other embodiments, if a difference between the quantity of audio frames and the quantity of key motion frames is very different, simply adjusting the multiplication speed may cause a playback joint to be not smooth, for example, the virtual character suddenly moves slowly, or the virtual character suddenly moves fast. In this way, motion smoothness and naturalness are apparently affected. Therefore, this embodiment of this disclosure further provides a manner of performing frame interpolation on or cropping a key motion frame, to improve the foregoing case and optimize the motion smoothness and naturalness. Classification discussion is performed below by using two cases: Case 1: The quantity of key motion frames does not exceed the quantity of audio frames of the audio clip. Case 2: The quantity of key motion frames exceeds the quantity of audio frames of the audio clip.

Case 1: The quantity of key motion frames does not exceed the quantity of audio frames of the audio clip

In some embodiments, the server may perform frame interpolation on the at least one key motion frame when the quantity of key motion frames does not exceed the quantity of audio frames of the audio clip, to obtain the motion clip having a same length as the audio clip.

In some embodiments, to ensure that the motion clip has the same length as the audio clip, frame interpolation may be performed on the at least one key motion frame. For example, one or more intermediate motion frames are interpolated between any pair or a plurality of pairs of neighboring key motion frames, where each intermediate motion frame is intermediate motion data calculated according to the pair of neighboring key motion frames into which the intermediate motion frame is interpolated.

In some embodiments, if a linear frame interpolation manner is used, intermediate motion data is actually calculated by using a linear interpolation method. For example, i (i≥1) intermediate motion frames are interpolated into a key motion frame 1 and a key motion frame 2. By using a same skeleton key point on the left shoulder as an example, the skeleton key point is in a pose θ₁ in the key motion frame 1, and the skeleton key point is in a pose θ₂ in the key motion frame 2. In this case, only i intermediate poses of the skeleton key point that transforms from the pose θ₁ to the pose θ₂ need to be calculated, so that the i intermediate poses of the skeleton key point in the i intermediate motion frames can be obtained. By analogy, the i intermediate poses are calculated for the whole body of skeleton key points, so that the i intermediate motion frames can be interpolated. In the linear interpolation method, the skeleton key point in the i intermediate motion frames uniformly changes according to a fixed step length. Alternatively, it may be considered that the skeleton key point moves at a constant speed. Therefore, the i intermediate poses are easily calculated provided that a fixed step length during interpolation of the i intermediate motion frames is calculated according to poses at an initial state and an end state (that is, the pose θ₁ and the Pose θ₂). In the foregoing linear frame interpolation manner, calculation resource consumption is low, calculation overheads are low, motion clip synthesis is fast, and a waiting delay is low.

In some other embodiments, a motion adjustment model is pre-trained. The motion adjustment model is configured to perform non-linear frame interpolation on the key motion frames when the quantity of key motion frames is less than the quantity of audio frames of the audio clip. In other words, the motion adjustment model is configured to learn a non-linear frame interpolation mode of the key motion frame. In the non-linear frame interpolation mode, fitting may be performed according to a motion curve, or a motion amplitude may be further fitted according to an audio tempo, to learn a pose change law under an amplitude change. A non-linear frame interpolation mode to be specifically learned is determined by using an inputted training sample. After training on the motion adjustment model is completed, the at least one key motion frame is inputted to the motion adjustment model, and the quantity of audio frames is used as a hyper-parameter for controlling, so that the motion adjustment model outputs at least one to-be-interpolated intermediate motion frame. In addition, each intermediate motion frame interpolated between two neighboring key motion frames does not uniformly change according to the fixed step length, but performs a pose change at a non-constant speed according to the non-linear frame interpolation mode learned by the motion adjustment model. Whether the linear frame interpolation manner is used is not specifically limited in the embodiments of this disclosure. In the foregoing non-linear frame interpolation manner based on the motion adjustment model, the mechanical feeling that may be brought by the linear frame interpolation manner can be improved, thereby optimizing smoothness of the motion clip.

In the foregoing processes, when the quantity of key motion frames is less than the quantity of audio frames, frame interpolation is performed on the key motion frames, so that a missed motion frame can be supplemented. In this way, an intermediate motion state is supplemented between neighboring key motion frames, making the virtual character in the motion clip move more coherently.

Case 2: The quantity of key motion frames exceeds the quantity of audio frames of the audio clip

In some embodiments, when the quantity of key motion frames exceeds the quantity of audio frames, a motion clip having a same length as the audio clip is created, and each frame of the motion clip is filled with a preset motion frame under a preset motion category. The preset motion category may be a default motion category preconfigured by the technical person, for example, a standing motion category or a sitting motion category without semantics. The preset motion category is not specifically limited herein, and the technical person may configure different preset motion categories for different virtual characters. The preset motion frame is a static motion frame preconfigured under the preset motion category. For example, when the preset motion category is a standing motion category, the preset motion frame is a standing motion frame; or when the preset motion category is a sitting motion category, the preset motion frame is a sitting motion frame. When the preset motion category is maintained, the virtual character usually keeps the same motion in a plurality of frames unchanged.

In the foregoing process, when the quantity of key motion frames exceeds the quantity of audio frames, the key motion frames are discarded, and the motion clip is filled with the preset motion frame. In this way, the key motion frames do not need to be played at a high speed, so that audience experience is not damaged, and a problem in the motion clip is not caused.

In some other embodiments, when the frame quantity of key motion frames exceeds the quantity of audio frames, the key motion frames may further be cropped. For example, some key motion frames at the head and the tail are discarded, so that the quantity of key motion frames after the cropping does not exceed the quantity of audio frames. In this way, it is avoided that the preset motion frame is used to fill an audio clip of a long token, and the motion generation effect is good. However, integrity of the key motion frames may be damaged. In this case, a motion smoothing operation in operation 309 needs to be used for improvement. Cropping logic of the key motion frames at the head and the tail may be configured by the technical person. For example, cropping is performed according to a set quantity of frames, or cutting is performed according to a set ratio. This is not specifically limited in the embodiments of this disclosure.

In operation B1 and operation B2, a possible motion clip synthesis manner is provided. In the synthesis manner, audio frames and key motion frames can be in a one-to-one correspondence, so that timestamps of the audio frames and the key motion frames are aligned. Even when the quantity of key motion frames does not match the quantity of audio frames, the manner of frame interpolation, cropping, or filling with the preset motion frame may also be used, to ensure successful synthesis of the motion clip, thereby improving efficiency of synthesizing the motion clip.

309: The server generates a motion sequence matching the audio based on each motion clip matching the audio clip of each token, the motion sequence being configured for controlling the virtual character to perform motions matching the audio.

In some embodiments, for each token in the text, the unique corresponding audio clip can be found in operation 306, and the unique corresponding motion clip can be synthesized in operation 308. Therefore, the audio clip in operation 306 and the motion clip in operation 308 can be in a one-to-one correspondence with the token by using the token as a bridge, and timestamps thereof are aligned. In this way, a motion sequence can be obtained provided that each motion clip is successively spliced according to a timestamp order of each audio clip, and it is ensured that each motion clip in the motion sequence highly matches an audio clip in the audio at the semantic level.

In some other embodiments, motion smoothing may be further performed on the spliced motion sequence, to increase naturalness and smoothness when different motion clips are joined. Detailed description is made below by using operation C1 and operation C2.

C1: The server splices each motion clip matching each audio clip based on a timestamp order of each audio clip, to obtain a spliced motion sequence.

In some embodiments, because the audio clip and the motion clip are in a one-to-one correspondence with the token by using the token as the bridge, for each motion clip, a timestamp interval of the corresponding audio clip may be found in the audio timeline, and then each motion clip is spliced according to an order of the timestamp interval, to obtain a spliced motion sequence. In some embodiments, the spliced motion sequence is directly outputted, to simplify the motion synthesis process. Alternatively, a motion smoothing operation in operation C2 is performed, to increase naturalness and smoothness when different motion clips are joined.

C2: The server performs motion smoothing on each motion frame in the spliced motion sequence, to obtain the motion sequence.

In some embodiments, in the spliced motion sequence obtained in operation C1, some may be key motion frames, some may be intermediate motion frames obtained through frame interpolation, and some may be filled preset motion frames. Therefore, each frame of motion data in the spliced motion sequence is referred to as one motion frame. The motion frame may be a key motion frame, an intermediate motion frame, or a preset motion frame. This is not specifically limited in the embodiments of this disclosure. Then, motion smoothing is performed on each motion frame in the spliced motion sequence, to obtain the final motion sequence.

In some embodiments, global processing is performed on each connected motion frame in a window smoothing manner, to obtain a motion sequence after global smoothing. The window smoothing manner refers to determining a pose of a same skeleton key point in each motion frame by using the skeleton key point as a unit. In this way, a series of pose changes of the skeleton key point in the motion sequence can be obtained, so that a pose change folding line can be fitted. Then, the pose change folding line is smoothed by using a moving window average smoothing algorithm, to obtain a pose change curve. Then, the pose of the skeleton key point in each motion frame is sampled from the pose change curve according to a timestamp, to obtain an updated pose of the skeleton key point in each motion frame. In this way, when a difference between motion categories matching two neighboring motion clips is large, joining of the two neighboring motion clips is smooth, coherent, and natural in the window smoothing manner. In this way, a motion sequence having a good visual effect is generated, thereby improving motion synthesis efficiency.

In some other embodiments, in addition to the window smoothing manner, the pose change folding line may also be smoothed by using another smoothing algorithm, or a pose change curve is directly fitted on the pose change folding line by using a machine. In this way, the motion smoothing effect can also be achieved.

In operation C1 and operation C2, motion smoothing is performed on the spliced motion sequence formed by mechanical splicing, so that joining of two neighboring motion clips is smooth, coherent, and natural. In this way, the motion sequence having the good visual effect is generated, thereby improving the motion synthesis efficiency. Certainly, the spliced motion sequence may alternatively be directly outputted without motion smoothing. This simplifies the motion synthesis process, thereby improving the motion synthesis efficiency.

In an exemplary scenario, FIG. 4 is still used as an example for description. For the text 42 “I first live-stream!”, the first token “I” matches the preset motion category “standing”, the second token “first” matches the motion category “cute shrug”, and the third token “live-stream!” matches the motion category “raise a hand happily”. Then, three motion clips are synthesized: a motion clip of standing, a motion clip of cute shrug, and a motion clip of raising a hand happily. For details of the motion clip synthesizing manner, reference is made to operation 308. Details are not described herein again. Next, the motion clip of standing, the motion clip of cute shrug, and the motion clip of raising a hand happily are spliced, to obtain a spliced motion sequence, and motion smoothing is performed on the spliced motion sequence, to obtain a finally outputted motion sequence. A smoothed pose change curve (that is, a motion curve) is further outputted in FIG. 4, to represent that the pose change curve of the skeleton key point in the outputted motion sequence is smooth and fluent, so that the mechanical feeling of the body motion can be removed. In some embodiments, this embodiment of this disclosure is applicable to synthesis of the body motion of the virtual character. However, a final picture can be generated only by combining a facial expression of the virtual character, and a final virtual character video (such as a digital human video) can be generated only by combining the picture and the audio.

In operation 306 to operation 309, a possible implementation of generating the motion sequence of the virtual character based on motion data is provided. When each motion category has massive motion data, a representative key motion frame having a highest semantic matching degree can be selected, to synthesize a series of motion clips, and splice the motion clips into a motion sequence. The motion sequence represents body motion changes of the virtual character at consecutive moments during audio broadcasting, and is configured for controlling the virtual character to perform body motions matching the audio during the audio broadcasting.

In the foregoing processes, each motion frame in the finally synthesized motion sequence is aligned with a timestamp of one audio frame in the audio, so that the motion frame reflects a body motion matching the audio frame at the semantic level. In this way, the sound-picture matching degree and accuracy are greatly improved, and a mechanical and rigid visual effect is not generated, so that the simulation degree and the personification degree of the virtual character can be improved, and a rendering effect of the virtual character can be optimized.

All the foregoing exemplary technical solutions can be arbitrarily combined to form an exemplary embodiment of the present disclosure. Details are not described herein again.

According to the method provided in this embodiment of this disclosure, by using audio and text as dual-modality driving signals, a semantic tag at a semantic level is extracted based on the text, to facilitate retrieval of a motion category matching the semantic tag from a preset motion library. The motion category can highly match semantic information of the audio, and can reflect a sentimental tendency and latent semantics of a virtual character during audio broadcasting. Then, motion data belonging to the motion category is retrieved, and a more accurate motion sequence is rapidly and efficiently synthesized for the virtual character based on the motion data, thereby improving motion generation efficiency of the virtual character and improving motion generation accuracy.

In addition, the motion sequence can be configured for controlling the virtual character to perform body motions matching the audio at the semantic level, instead of simply making a rhythm with an audio tempo. In this way, the sound-picture matching degree and accuracy are greatly improved, and a mechanical and rigid visual effect is not generated, so that the simulation degree and the personification degree of the virtual character can be improved, and a rendering effect of the virtual character can be optimized.

In the foregoing motion generation solution, a latent mapping relationship between the text and the body motions of the audio is mined, and an automatic procedure of generating the body motion of the virtual character triggered by dual modalities of the text and the audio is implemented without manual intervention. In this way, performance of a real person in combination with a motion capture system is not required, and an animator does not need to perform animation restoration; and a motion sequence of the body motions of the virtual character can be rapidly and automatically generated by a machine when the text and the audio are given, which replaces a complex motion capture and restoration procedure. In addition, the solution has strong universality, can be used in a body motion generation task of a virtual character in various scenarios such as gaming, live streaming, animation, and movie and television, and has very high practicability. In addition, device, manpower, and time costs are greatly reduced, the application is simple and rapid without dependence, and generation of the motion sequence has high quality and high accuracy.

In each of the foregoing embodiments, the method for generating a motion of a virtual character is described in detail, so that a motion sequence highly matching at the semantic level can be rapidly and automatically synthesized on the dual-modality driving signals of the audio and the text without manual intervention. The foregoing motion generation solution relies on a completely constructed preset motion library, and a process of constructing the preset motion library is described in detail in the embodiments of this disclosure.

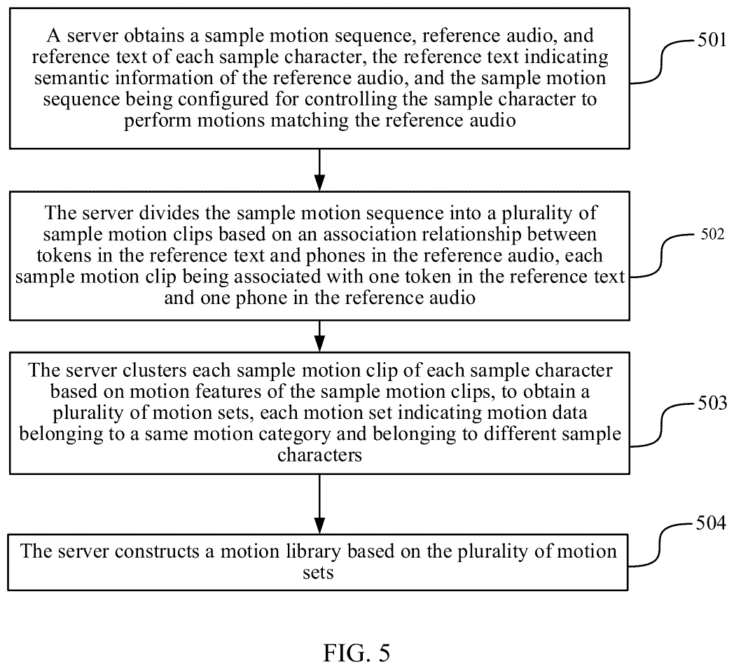

FIG. 5 is a flowchart of a method for constructing a motion library of a virtual character according to an embodiment of this disclosure. Referring to FIG. 5, this embodiment is performed by a computer device. An example in which the computer device is a server is used for description. The server may be the server 102 in the foregoing implementation environment. This embodiment includes the following operations:

501: The server obtains a sample motion sequence, reference audio, and reference text of each sample character, the reference text indicating semantic information of the reference audio, and the sample motion sequence being configured for controlling the sample character to perform motions matching the reference audio.

The sample character is a virtual character or a real character that is public, acquirable, and acquired with conformity. For example, the sample character is a virtual character such as an animation person, a virtual anchor, or a digital human, or may be a real character such as an actor, a speaker, or an anchor. This is not specifically limited in the embodiments of this disclosure.

Acquisition and use of the sample motion sequence, the reference audio, and the reference text of the sample character conform to the rule. The sample motion sequence has reference audio (that is, a voice-over) and reference text (that is, subtitles or text obtained through audio recognition) in a one-to-one correspondence.

In some embodiments, the server obtains sample motion sequences of a plurality of sample characters and removes a low-quality sample not labeled with both reference audio and reference text; may further remove a low-quality sample not including a body motion (for example, only a head of a virtual character can be seen at a viewing angle); and may further remove a low-quality sample lasting for excessively short or excessively long duration. For example, only sample motion sequences lasting for 1 to 10 s are reserved. If a sample motion sequence has both reference audio and reference text, the three are correspondingly stored. If a sample motion sequence has only reference audio, ASR is performed on the reference audio, to obtain corresponding reference text, and the three are correspondingly stored. If a sample motion sequence has only reference text, the reference text is dubbed (that is, speech synthesis is performed based on the text), to obtain corresponding reference audio, and the three are correspondingly stored. A quantity of sample characters and a quantity of sample motion sequences are not specifically limited herein.

502: The server divides the sample motion sequence into a plurality of sample motion clips based on an association relationship between tokens in the reference text and phones in the reference audio, each sample motion clip being associated with one token in the reference text and one phone in the reference audio.

In some embodiments, the server performs processing by using each sample motion sequence as a unit, to obtain reference text and reference audio that are stored corresponding to the sample motion sequence. Further, it can be known from the foregoing embodiment that, the association relationship between the tokens in the reference text and the phones in the reference audio can be constructed in a phone alignment manner, and then the sample motion sequence may be divided into the plurality of sample motion clips based on the association relationship.

In some embodiments, a possible sample motion clip division manner is described by using the following operation D1 and operation D2.

D1: For each token in the reference text, the server determines, based on a phone associated with the token, a sample audio clip associated with the phone from the reference audio.

Operation D1 is similar to operation 306 in the foregoing embodiment. Details are not described herein again.

D2: The server divides the sample motion sequence into the plurality of sample motion clips based on a timestamp interval of each sample audio clip, a timestamp interval of each sample motion clip being aligned with a timestamp interval of one sample audio clip.

In some embodiments, for each sample audio clip, a starting timestamp of a first audio frame and an ending timestamp of a last audio frame in the sample audio clip can be found in an audio timeline. The starting timestamp and the ending timestamp form a timestamp interval. Because the reference audio, the reference text, and the sample motion sequence are aligned by using timestamps, segmentation is directly performed in the sample motion sequence according to the timestamp interval of each sample audio clip. In this way, the plurality of sample motion clips can be obtained through division, and it is also ensured that the timestamp interval of each sample motion clip is aligned with the timestamp interval of the sample audio clip.

503: The server clusters each sample motion clip of each sample character based on motion features of the sample motion clips, to obtain a plurality of motion sets, each motion set indicating motion data belonging to a same motion category and belonging to different sample characters.

In some embodiments, the server performs operation 502 on each sample motion sequence to divide into a plurality of sample motion clips, to obtain a series of sample motion clips from different sample characters or different sample motion sequences; and then, extracts, for each sample motion clip, a motion feature of the sample motion clip. In some embodiments, the server trains a motion feature extraction model, and inputs the sample motion clip to the motion feature extraction model; and the motion feature extraction model processes the sample motion clip, and outputs the motion feature of the sample motion clip.

Further, when a motion feature of each sample motion clip is extracted, each sample motion clip is clustered based on a clustering algorithm, to form the plurality of motion sets. Each motion set represents a motion category, and each motion set includes motion data belonging to the corresponding motion category (that is, each sample motion clip clustered to the motion category). The clustering algorithm includes, but is not limited to, a K-nearest neighbor (KNN) clustering algorithm, a K-means (K-means) clustering algorithm, a hierarchical clustering algorithm, or the like.

In an exemplary scenario, a process of clustering sample motion clips is described by using the K-means clustering algorithm as an example. The K-means clustering algorithm is an iteratively solved cluster analysis algorithm, and operations of the algorithm include: dividing all the sample motion clips into K motion categories, randomly selecting K sample motion clips as initial clustering centers of the K motion categories, calculating distances between each remaining sample motion clip and the K initial clustering centers (actually, calculating distances between motion features), and allocating each remaining sample motion clip to a clustering center nearest to the remaining sample motion clip. A clustering center and remaining sample motion clips allocated to the clustering center represent a motion set. Each time a sample motion clip is newly allocated to a motion set, a clustering center of the motion set is recalculated according to all existing sample motion clips. The foregoing process is continuously repeated until a termination condition is met. The termination condition includes, but is not limited to: No (or a minimum quantity of) sample motion clips are re-allocated to different motion sets, no (or a minimum quantity of) clustering centers change again, a quadratic sum of an error of K-means clustering is locally smallest, or the like. A termination condition of the K-means clustering algorithm is not specifically limited in the embodiments of this disclosure.

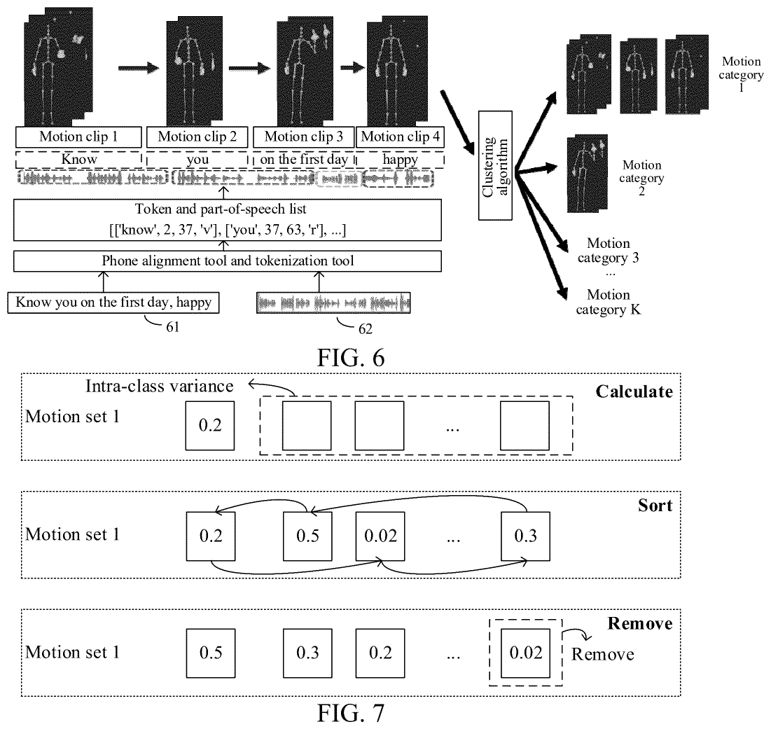

In an exemplary scenario, FIG. 6 is a principle diagram of a method for creating a motion library according to an embodiment of this disclosure. A single sample motion sequence is used as an example for description. Reference text 61 and reference audio 62 of a sample motion sequence are obtained. For example, the reference text 61 is “Know you on the first day, happy”. Then, tokenization is performed on the reference text 61 by using a tokenization tool, to obtain five tokens “know”, “you”, “on”, “the first day”, and “happy”. Then, a part-of-speech tag of each token is found by using a part-of-speech table. For example, a part-of-speech tag of “know” is a “verb (v)”, and a part-of-speech tag of “first day” is “time”. Then, a first frame sequence number and a last frame sequence number of a sample audio clip aligned with each token are recognized by using a phone alignment tool. For example, a sample audio clip of “know” is 2 to 37 frames. Through the foregoing operations, a quadruple [token, first frame sequence number, last frame sequence number, part-of-speech tag] can be constructed for each token. For example, a quadruple of the token “know” is [‘know’, 2, 37, ‘v’]. The quadruple of each token is spliced to obtain a part-of-speech sequence. Then, the sample motion sequence is divided into four sample motion clips according to the sample audio clip of each token. Because a sample motion clip of the token “on” has excessively short duration, sample motion clips of the tokens “you” and “on” are combined into one sample motion clip, and timestamp alignment is performed on the tokens, the sample audio clips, and the sample motion clips. Next, after each sample motion sequence is divided into a plurality of sample motion clips in the foregoing manner, each sample motion clip is inputted to the clustering algorithm, to obtain motion sets of K motion categories, where K is an integer greater than or equal to 2.

In some other embodiments, the motion set of each motion category can be further subdivided into a plurality of sub-categories in a similar manner. A process of clustering the sub-categories is similar to the process of clustering the motion categories. Details are not described herein again. Through the clustering manner, massive motion data can be divided into a plurality of motion categories, and it is ensured that motion data in each motion category has a similarity and motion data between different motion categories has a difference. In this way, it is considered that each motion category can represent one motion semantic meaning, that is, motion data belonging to different motion categories is different from each other at a semantic level.

504: The server constructs a motion library based on the plurality of motion sets.

In some embodiments, the server directly constructs the motion library based on the K motion sets formed through clustering in operation 503. The motion library includes the K motion sets, that is, includes motion data of a virtual character belonging to the K motion categories.

In some embodiments, category features of the motion categories to which the K motion sets respectively belong are further calculated and stored. In this way, the process of creating the motion library is simplified, and efficiency of creating the motion library is sped up.

In still other embodiments, further data cleaning may be performed on the K motion sets formed through clustering in operation 503, to filter out an outlier sample deviating from a clustering center in each motion set, thereby improving a similarity of each sample motion clip in a same motion category, and reducing a similarity of each sample motion clip in different motion categories. A data cleaning procedure of a single motion set is described below by using operation E1 to operation E4 as an example.

E1: The server obtains, for each motion set, a category feature of the motion category indicated by the motion set, the category feature being an average motion feature of each sample motion clip in the motion set.

In some embodiments, for each motion set formed through clustering in operation 503, an average motion feature is calculated according to the motion feature of each sample motion clip in the motion set, and is used as the category feature of the motion category indicated by the motion set. The category feature represents a clustering center of the motion set.

E2: The server determines a contribution score of the motion feature of each sample motion clip in the motion set to the category feature, the contribution score representing a matching degree between the sample motion clip and the motion category.

Although each sample motion clip belongs to one motion category, different sample motion clips may have different matching degrees with motion categories. The matching degree is configured for measuring whether a motion performed in the sample motion clip is standard. For example, a category feature of a motion category is an average motion feature of a plurality of sample motion clips in a motion set. However, motion features of some sample motion clips in the motion set are similar to the average motion feature, indicating that motions that are performed in the sample motion clips and that belong to the motion category are standard. However, motion features of some sample motion clips are not similar to the average motion feature, indicating that although motions belonging to the motion category are also performed in the sample motion clips, but the performed motions are not standard. Therefore, the contribution score represents the standard degree of the sample motion clip to the motion category.

In some embodiments, for each sample motion clip in the motion set, the contribution score of the motion feature of the sample motion clip to the category feature in operation E1 is calculated. In some embodiments, a feature similarity between the motion feature and the category feature is directly calculated, and then exponential normalization is performed on a feature similarity of each sample motion clip in the entire motion set, to obtain a contribution score (referring to a feature similarity after exponential normalization) of each sample motion clip. In this way, the feature similarity after index normalization is used as a metric indicator of the contribution score, so that complexity of calculating the contribution score can be reduced, and efficiency of calculating the contribution score can be improved.

In some other embodiments, an intra-class variance (also referred to as an (N−1) variance) after an individual is excluded is provided as a metric indicator of the contribution score. In this way, the intra-class variance represents contribution of the excluded individual to entire clustering, that is, reflects a contribution score of an excluded sample motion clip to the entire motion set. A better performance capability of the contribution score indicates a more accurate metric dimension. A larger contribution score indicates a more standard motion in the sample motion clip, and a smaller contribution score indicates a less standard motion in the sample motion clip. A manner of obtaining an intra-class variance (that is, a possible contribution score) of a single sample motion clip is described in detail below by using operation E21 and operation E22.

E21: The server obtains, for any sample motion clip in the motion set, a motion score of each remaining motion clip other than the sample motion clip, the motion score representing a similarity between the remaining motion clip and the category feature.

The remaining motion clip is a sample motion clip other than the sample motion clip in the motion set.

In some embodiments, for each sample motion clip in the motion set, the feature similarity between the motion feature of the sample motion clip and the category feature in operation E1 is calculated, and then exponential normalization is performed on the feature similarity of each sample motion clip in the entire motion set, to obtain a motion score (referring to a feature similarity after exponential normalization) of each sample motion clip. Then, the current sample motion clip is excluded, and the motion score of each remaining motion clip other than the sample motion clip is determined.

E22: The server determines, based on the motion score of each remaining motion clip, an intra-class variance after the sample motion clip is excluded, and determines the intra-class variance as the contribution score of the sample motion clip.

In some embodiments, the server calculates an average value of motion scores of all remaining motion clips obtained in operation E21; uses the average value as an average motion score; determines, based on the average motion score and the motion score of each remaining motion clip, the intra-class variance after the sample motion clip is excluded; and determines the intra-class variance as the contribution score of the sample motion clip.

In an example, assuming that a motion set includes N sample motion clips, by using an example in which an N^{th} sample motion clip is excluded, the remaining motion clips are first to (N−1)^{th} sample motion clips, and the intra-class variance (also referred to as the (N−1) variance) is obtained by using the following formula:

$${S}_{N - 1} = \sqrt{\frac{{\sum }_{i}^{N - 1} ( {x}_{i} - {\overline{x}}_{N - 1} )}{N - 1}}$$

S_{N-1} indicates an intra-class variance of the N^{th} sample motion clip, where i is an integer greater than or equal to 1 and less than or equal to N−1; xᵢ indicates a motion score of an i^{th} sample motion clip; and x̅_{N-1} indicates an average motion score, where the average motion score is an average value of motion scores of the (N−1) remaining motion clips.

In the foregoing process, the intra-class variance (also referred to as the (N−1) variance) after the individual is excluded is provided as the metric indicator of the contribution score. This actually means that an intra-class variance of a remaining individual is calculated after a specified individual is excluded. In this case, a larger intra-class variance indicates smaller impact of the excluded individual on deviation from clustering and larger impact of the remaining individual on deviation from clustering. Therefore, the intra-class variance can measure contribution of the excluded individual to entire clustering well, that is, reflects the contribution score of the excluded sample motion clip to the entire motion set. A better performance capability of the contribution score indicates a more precise metric dimension. A larger contribution score indicates a more standard motion in the sample motion clip, and a smaller contribution score indicates a less standard motion in the sample motion clip. In this case, a sample motion clip that is not standard (that is, a sample motion clip with a low contribution score) needs to be considered to be removed, thereby facilitating data cleaning inside each motion category.

E3: The server removes, from the motion set, a sample motion clip whose contribution score meets a removal condition.

In some embodiments, the server may sort sample motion clips in the motion set in descending order of contribution scores, and removes a sample motion clip ranked last in the sort. In this way, only a sample motion clip having smallest impact on deviation from clustering is discarded each time data cleaning is performed, thereby avoiding incorrect removal of a high-quality sample motion clip.

In some other embodiments, the server may further sort the sample motion clips in the motion set in descending order of contribution scores, and removes j sample motion clips ranked last in the sort. In this way, j sample motion clips having smaller impact on deviation from clustering are discarded each time data cleaning is performed. In this way, a data cleaning rate of the motion set can be finely controlled by flexibly controlling a value of j. j is an integer greater than or equal to 1.

In an example, FIG. 7 is a principle diagram of data cleaning for a motion set according to an embodiment of this disclosure. For a motion set of a motion category, after a first sample motion clip is excluded, intra-class variances of remaining (N−1) remaining motion clips are calculated, to obtain a contribution score 0.2 of the first sample motion clip. The foregoing operation is repeated for each sample motion clip to calculate a contribution score of each sample motion clip, then the sample motion clips are sorted in descending order of contribution scores, and then a sample motion clip ranked last in the sort is removed. For example, a sample motion clip ranked last whose contribution score is 0.02 is removed.

E4: The server updates the category feature and the contribution score based on a motion set obtained after the removing, iteratively performs a removal operation for a plurality of times, and stops iteration when an iteration stop condition is met.

In some embodiments, because one (or more) sample motion clips with lower contribution scores are removed in operation E3, because a quantity of samples in the motion set changes, the clustering center, namely, the category feature, of the sample motion clip certainly needs to be recalculated. Therefore, the category feature is updated based on a manner similar to operation E1. Correspondingly, because the category feature changes, the contribution score of each sample motion clip also certainly needs to be recalculated. Therefore, the contribution score is updated based on a manner similar to operation E2, and then, a sample motion clip whose contribution score meets the removal condition is removed based on a manner similar to operation E3 and the updated contribution score. Operation E1 to operation E3 are iteratively performed, and the iteration is stopped when the iteration stop condition is met, to obtain a pure high-quality motion set. The iteration stop condition includes, but is not limited to: The quantity of times of iteration reaches a quantity-of-times threshold, where the quantity-of-times threshold is an integer greater than 0; or a sample capacity of the motion set is reduced to a preset capacity, where the preset capacity is an integer greater than or equal to 1; or a contribution score ranked last is greater than a contribution threshold, where the contribution threshold is a value greater than or equal to 0. The iteration stop condition is not specifically limited in the embodiments of this disclosure.

In the foregoing operation E1 to operation E4, because the motion set directly formed through clustering is coarse and some motions having a large intra-class difference may exist, the motions need to be removed, to avoid affecting clustering accuracy of the motion categories. In this way, a manner of performing data cleaning, data filtering, or data purification on each motion set is provided. Finally, a motion library constructed based on the cleaned motion set has a good motion generation effect and high availability, and the entire iterative sorting and filtering procedure can be implemented in a self-supervised manner without manual intervention. Therefore, the library creation stage can also be automatically implemented, so that library creation costs are low and library creation efficiency is high.

In the foregoing operation 501 to operation 504, a procedure of creating a motion library that provides support for a method for generating a motion of a virtual character is described in detail. In some embodiments, considering that the motion library cannot be fixed, some pieces of motion data usually need to be expanded or newly added. A procedure of adding a newly added motion sequence to the library is described below by using operation F1 to operation F4 as an example.

F1: The server obtains, for any newly added motion sequence outside the motion library, newly added reference audio and newly added reference text associated with the newly added motion sequence.

The newly added reference text indicates semantic information of the newly added reference audio, and the newly added motion sequence is configured for controlling a corresponding sample character to perform motions matching the newly added reference audio.

Operation F1 is similar to operation 501. Details are not described herein again.

F2: The server divides the newly added motion sequence into a plurality of newly added motion clips based on an association relationship between tokens in the newly added reference text and phones in the newly added reference audio.

Each newly added motion clip is associated with one token in the newly added reference text and one phone in the newly added reference audio.

Operation F2 is similar to operation 502. Details are not described herein again.

F3: For each newly added motion clip, the server determines, based on a motion feature of the newly added motion clip, a target motion set to which the newly added motion clip belongs from the plurality of motion sets in the preset motion library.

In some embodiments, for each newly added motion clip, the motion feature of the newly added motion clip is calculated based on a manner similar to operation 503, then a distance between the motion feature of the newly added motion clip and a category feature of each motion set is calculated, and the newly added motion clip is allocated to a target motion set having a nearest distance.

F4: The server adds the newly added motion clip to the target motion set, updates the category feature and the contribution score, and removes, from the target motion set, a sample motion clip whose contribution score meets the removal condition.

In some embodiments, after the newly added motion clip is allocated to the target motion set, because a quantity of samples in the target motion set changes, the clustering center, namely, the category feature, of the sample motion clip certainly needs to be recalculated. Therefore, the category feature is recalculated based on a manner similar to operation E1. Correspondingly, because the category feature changes, the contribution score of each sample motion clip (including the newly added motion clip) also certainly needs to be recalculated. Therefore, the contribution score is recalculated based on a manner similar to operation E2, and then, a sample motion clip whose contribution score meets the removal condition is removed based on a manner similar to operation E3 and the recalculated new contribution score.

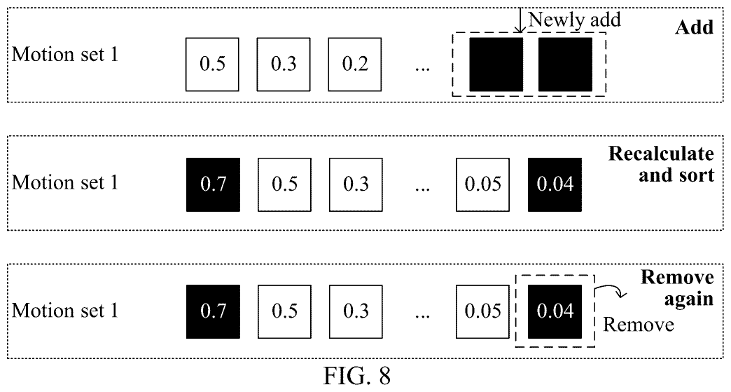

In an example, FIG. 8 is a principle diagram of data supplement of a newly added motion clip according to an embodiment of this disclosure. For a target motion set into which a newly added motion clip falls, it is assumed that two newly added motion clips are added, and it is calculated, based on a manner similar to operation E2, that contribution scores of the two newly added motion clips are respectively 0.7 and 0.04. In this case, the two newly added motion clips are included, all sample motion clips in the entire target motion set are re-sorted (in a reverse order) according to contribution scores, and a sample motion clip ranked last after the re-sorting is removed. For example, a newly added motion clip ranked last whose contribution score is 0.04 is removed.

All the foregoing exemplary technical solutions can be arbitrarily combined to form an exemplary embodiment of the present disclosure. Details are not described herein again.

According to the method provided in this embodiment of this disclosure, a sample motion sequence is divided into a series of sample motion clips according to guidance of reference text and reference audio, and then the sample motion clips are divided into a plurality of motion categories through clustering, where each motion category has a motion set for storing motion data clustered to the motion category. In this way, a motion library including the plurality of motion categories can be constructed, so that motion data belonging to different motion categories is distinguished at a semantic level, to facilitate subsequent investment into a motion generation process. In addition, a most matched motion category is detected by using a semantic tag as an index, so that motion generation efficiency and accuracy can be improved.

In the foregoing motion library construction solution, mechanisms of automatic learning semantic production, automatic classification, and automatic filtering are provided, so that it is convenient to automatically remove a low-quality sample and add a new sample to any motion category at any time. In addition, motion data in a motion category is re-cleaned by using only a contribution score, thereby ensuring high quality of the motion library, and also improving uniformity of motion data in each motion category.

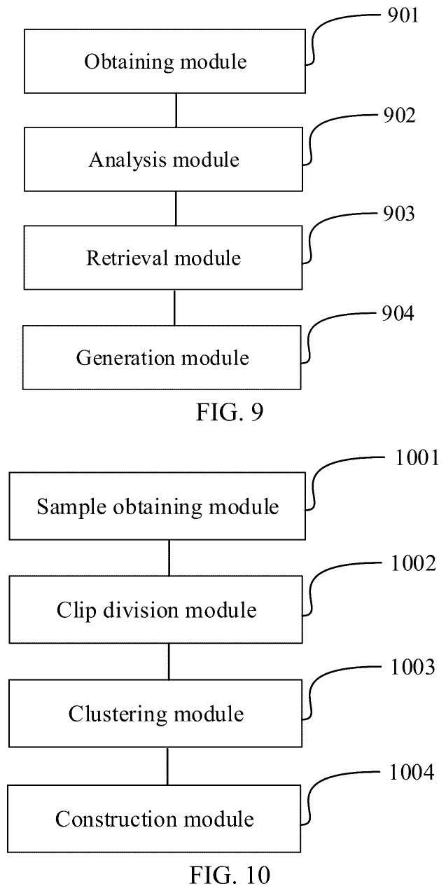

FIG. 9 is a schematic structural diagram of an apparatus for generating a motion of a virtual character according to an embodiment of this disclosure. As shown in FIG. 9, the apparatus includes:
an obtaining module 901, configured to obtain audio and text of a virtual character, the text indicating semantic information of the audio;
an analysis module 902, configured to determine a semantic tag of the text based on the text, the semantic tag representing at least one of part-of-speech information of a token in the text or sentiment information expressed by the text;
a retrieval module 903, configured to retrieve a motion category matching the semantic tag and motion data belonging to the motion category from a preset motion library, the preset motion library including motion data of the virtual character belonging to a plurality of motion categories; and
a generation module 904, configured to generate a motion sequence of the virtual character based on the motion data, the motion sequence being configured for controlling the virtual character to perform motions matching the audio.

According to the apparatus provided in this embodiment of this disclosure, by using audio and text as dual-modality driving signals, a semantic tag at a semantic level is extracted based on the text, to facilitate retrieval of a motion category matching the semantic tag from a preset motion library. The motion category can highly match semantic information of the audio, and can reflect a sentimental tendency and latent semantics of a virtual character during audio broadcasting. Then, motion data belonging to the motion category is retrieved, and a more accurate motion sequence is rapidly and efficiently synthesized for the virtual character based on the motion data, thereby improving motion generation efficiency of the virtual character and improving motion generation accuracy.

Further, the motion sequence can be configured for controlling the virtual character to perform body motions matching the audio at the semantic level, instead of simply making a rhythm with an audio tempo. In this way, the sound-picture matching degree and accuracy are greatly improved, and a mechanical and rigid visual effect is not generated, so that the simulation degree and the personification degree of the virtual character can be improved, and a rendering effect of the virtual character can be optimized.

In some embodiments, the analysis module 902 is configured to determine a sentiment tag of the text based on the text; determine, based on the text, at least one token included in the text; query, from a part-of-speech table, a part-of-speech tag of each token; and determine the sentiment tag and the part-of-speech tag of the at least one token as the semantic tag of the text.

In some embodiments, the retrieval module is configured to: for each token included in the text, retrieve, based on a semantic tag of the token, a motion category matching the semantic tag from the preset motion library; and retrieve motion data belonging to the motion category from the preset motion library.

In some embodiments, based on the apparatus composition in FIG. 9, the generation module 904 includes:
a determining unit, configured to: for each token included in the text, determine, based on a phone associated with the token, an audio clip to which the phone belongs from the audio;
a clip generation unit, configured to generate a motion clip matching the audio clip based on the motion data and the audio clip corresponding to the token; and
a sequence generation unit, configured to generate the motion sequence matching the audio based on each motion clip matching the audio clip of each token.

In some embodiments, based on the apparatus composition in FIG. 9, the clip generation unit includes:
a determining subunit, configured to determine, from the motion data, at least one key motion frame whose semantic matching degree with the token is highest; and
a synthesis subunit, configured to synthesize, based on the audio clip, the at least one key motion frame into the motion clip matching the audio clip.

In some embodiments, the synthesis subunit is configured to perform frame interpolation on the at least one key motion frame when a quantity of key motion frames does not exceed a quantity of audio frames of the audio clip, to obtain the motion clip having a same length as the audio clip; and when the quantity of key motion frames exceeds the quantity of audio frames, create a motion clip having a same length as the audio clip, and fill each frame of the motion clip with a preset motion frame under a preset motion category.

In some embodiments, the sequence generation unit is configured to splice each motion clip matching each audio clip based on a timestamp order of each audio clip, to obtain a spliced motion sequence; and perform motion smoothing on each motion frame in the spliced motion sequence, to obtain the motion sequence.

In some embodiments, the retrieval module 903 is configured to extract a semantic feature of the semantic tag; query category features of a plurality of candidate categories in the preset motion library; and determine the motion category from the plurality of candidate categories, the category feature of the motion category and the semantic feature meeting a similarity condition.

In some embodiments, the retrieval module 903 is further configured to configure the motion category matching the semantic tag as a preset motion category when the category features of the plurality of candidate categories and the semantic feature do not meet the similarity condition.

All the foregoing exemplary technical solutions can be arbitrarily combined to form an exemplary embodiment of the present disclosure. Details are not described herein again.

The apparatus for generating a motion of a virtual character provided in the foregoing embodiments is illustrated with an example of division of the foregoing functional modules when a body motion of the virtual character is generated. In actual application, the functions can be allocated to and completed by different functional modules according to requirements, that is, the internal structure of the computer device is divided into different functional modules, to implement all or some of the functions described above. In addition, the apparatus for generating a motion of a virtual character and the method for generating a motion of a virtual character provided in the foregoing embodiments belong to the same concept. For a specific implementation process, reference is made to the embodiments of the method for generating a motion of a virtual character. Details are not described herein again.

FIG. 10 is a schematic structural diagram of an apparatus for constructing a motion library of a virtual character according to an embodiment of this disclosure. As shown in FIG. 10, the apparatus includes:
a sample obtaining module 1001, configured to obtain a sample motion sequence, reference audio, and reference text of each sample character, the reference text indicating semantic information of the reference audio, and the sample motion sequence being configured for controlling the sample character to perform motions matching the reference audio;
a clip division module 1002, configured to divide the sample motion sequence into a plurality of sample motion clips based on an association relationship between tokens in the reference text and phones in the reference audio, each sample motion clip being associated with one token in the reference text and one phone in the reference audio;
a clustering module 1003, configured to cluster each sample motion clip of each sample character based on motion features of the sample motion clips, to obtain a plurality of motion sets, each motion set indicating motion data belonging to a same motion category and belonging to different sample characters; and
a construction module 1004, configured to construct a motion library based on the plurality of motion sets.

According to the apparatus provided in this embodiment of this disclosure, a sample motion sequence is divided into a series of sample motion clips according to guidance of reference text and reference audio, and then the sample motion clips are divided into a plurality of motion categories through clustering, where each motion category has a motion set for storing all motion data clustered to the motion category. In this way, a motion library including the plurality of motion categories can be constructed, so that motion data belonging to different motion categories is distinguished at a semantic level, to facilitate subsequent investment into a motion generation process. In addition, a most matched motion category is detected by using a semantic tag as an index, so that motion generation efficiency and accuracy can be improved.

In some embodiments, the segment division module 1002 is configured to: for each token in the reference text, determine, based on a phone associated with the token, a sample audio clip associated with the phone from the reference audio; and divide the sample motion sequence into the plurality of sample motion clips based on a timestamp interval of each sample audio clip, a timestamp interval of each sample motion clip being aligned with a timestamp interval of one sample audio clip.

In some embodiments, based on the apparatus composition in FIG. 10, the apparatus further includes:
a feature obtaining module, configured to obtain, for each motion set, a category feature of the motion category indicated by the motion set, the category feature being an average motion feature of each sample motion clip in the motion set;
a determining module, configured to determine a contribution score of a motion feature of each sample motion clip in the motion set to the category feature, the contribution score representing a matching degree between the sample motion clip and the motion category;
a removal module, configured to remove, from the motion set, a sample motion clip whose contribution score meets a removal condition; and
an iteration module, configured to update the category feature and the contribution score based on a motion set obtained after the removing, iteratively perform a removal operation for a plurality of times, and stop iteration when an iteration stop condition is met.

In some embodiments, the determining module is configured to obtain, for any sample motion clip in the motion set, a motion score of each remaining motion clip other than the sample motion clip, the motion score representing a similarity between the remaining motion clip and the category feature; and determine, based on the motion score of each remaining motion clip, an intra-class variance after the sample motion clip is excluded, and determine the intra-class variance as the contribution score of the sample motion clip.

In some embodiments, the removal module is configured to sort sample motion clips in the motion set in descending order of contribution scores, and remove a sample motion clip ranked last in the sort.

In some embodiments, the sample obtaining module 1001 is further configured to obtain, for any newly added motion sequence outside the preset motion library, newly added reference audio and newly added reference text associated with the newly added motion sequence;
the clip division module 1002 is further configured to divide the newly added motion sequence into a plurality of newly added motion clips based on an association relationship between tokens in the newly added reference text and phones in the newly added reference audio;
the clustering module 1003 is further configured to: for each newly added motion clip, determine, based on a motion feature of the newly added motion clip, a target motion set to which the newly added motion clip belongs from the plurality of motion sets in the preset motion library; and
the construction module 1004 is further configured to add the newly added motion clip to the target motion set, update the category feature and the contribution score, and remove, from the target motion set, a sample motion clip whose contribution score meets the removal condition.

All the foregoing exemplary technical solutions can be arbitrarily combined to form an exemplary embodiment of the present disclosure. Details are not described herein again.

The apparatus for constructing a motion library of a virtual character provided in the foregoing embodiments is illustrated with an example of division of the foregoing functional modules when the motion library is constructed. In actual application, the functions can be allocated to and completed by different functional modules according to requirements, that is, the internal structure of the computer device is divided into different functional modules, to implement all or some of the functions described above. In addition, the apparatus for constructing a motion library of a virtual character and the method for constructing a motion library of a virtual character provided in the foregoing embodiments belong to the same concept. For a specific implementation process, reference is made to the embodiments of the method for constructing a motion library of a virtual character. Details are not described herein again.

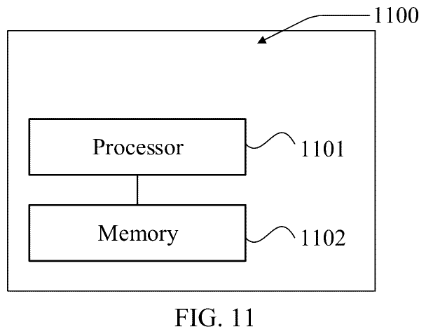

FIG. 11 is a schematic structural diagram of a computer device according to an embodiment of this disclosure. As shown in FIG. 11, a computer device 1100 may vary greatly due to different configurations or performance, and the computer device 1100 may include one or more central processing units (CPUs) 1101 and one or more memories 1102. The memory 1102 has at least one computer program stored therein, the at least one computer program being loaded and executed by the processor 1101 to implement the method for generating a motion of a virtual character or the method for constructing a motion library of a virtual character provided in the foregoing embodiments. In some embodiments, the computer device 1100 also has components such as a wired or wireless network interface, a keyboard, and an input/output interface for ease of input/output, and the computer device 1100 also includes other components for implementing functions of the device, which will not be described in detail herein.

In an exemplary embodiment, a computer-readable storage medium, for example, a memory including at least one computer program, is further provided. The at least one computer program may be executed by a processor in a computer device to implement the method for generating a motion of a virtual character or the method for constructing a motion library of a virtual character in the foregoing embodiments. For example, the computer-readable storage medium includes a read-only memory (ROM), a random-access memory (RAM), a compact disc read-only memory (CD-ROM), a magnetic tape, a floppy disk, an optical data storage device, or the like.

In an exemplary embodiment, a computer program product is further provided, including one or more computer programs, the computer one or more computer programs being stored in a computer-readable storage medium. One or more processors of a computer device can read the one or more computer programs from the computer-readable storage medium, and the one or more processors execute the one or more computer programs, to cause the computer device to perform the method for generating a motion of a virtual character or the method for constructing a motion library of a virtual character in the foregoing embodiments.

A person of ordinary skill in the art can understand that all or some of the steps of the foregoing embodiments can be implemented by hardware, or can be implemented by a program instructing relevant hardware. In some embodiments, the program is stored in a computer-readable storage medium. In some embodiments, the foregoing storage medium is a read-only memory, a magnetic disk, an optical disc, or the like.

The foregoing descriptions are merely exemplary embodiments of this disclosure, but are not intended to limit this disclosure. Any modification, equivalent replacement, or improvement made within the spirit and principle of this disclosure shall fall within the protection scope of this disclosure.

What is claimed is:

1. A method for generating a motion of a virtual character, applied to a computer device, the method comprising:
obtaining audio and text of a virtual character, wherein the text indicates semantic information of the audio;
determining a semantic tag of the text based on the text, wherein the semantic tag represents at least one of part-of-speech information of a token in the text or sentiment information expressed by the text;
retrieving a motion category matching the semantic tag and motion data belonging to the motion category from a preset motion library, the preset motion library comprising motion data of the virtual character belonging to a plurality of motion categories; and
generating a motion sequence of the virtual character based on the motion data, wherein the motion sequence is configured for controlling the virtual character to perform motions matching the audio.

2. The method for generating the motion of the virtual character according to claim 1, wherein determining the semantic tag of the text based on the text comprises:
determining, based on the text, at least one token comprised in the text;
querying, from a part-of-speech table, a part-of-speech tag of each token; and
determining a sentiment tag and the part-of-speech tag of the at least one token as the semantic tag of the text.

3. The method for generating the motion of the virtual character according to claim 1, wherein retrieving the motion category matching the semantic tag and the motion data belonging to the motion category from the preset motion library comprises:
retrieving, for each token comprised in the text, based on the semantic tag of the token, the motion category matching the semantic tag from the preset motion library; and
retrieving the motion data belonging to the motion category from the preset motion library.

4. The method for generating the motion of the virtual character according to claim 3, wherein generating the motion sequence of the virtual character based on the motion data comprises:
determining, for each token comprised in the text, based on a phone associated with the token, an audio clip to which the phone belongs; and generating a motion clip matching the audio clip based on the motion data and the audio clip corresponding to the token; and
generating the motion sequence matching the audio based on each motion clip matching the audio clip of each token.

5. The method for generating the motion of the virtual character according to claim 4, wherein generating the motion clip matching the audio clip based on the motion data and the audio clip corresponding to the token comprises:
determining, from the motion data, at least one key motion frame whose semantic matching degree with the token is highest; and
synthesizing, based on the audio clip, the at least one key motion frame into the motion clip matching the audio clip.

6. The method for generating the motion of the virtual character according to claim 5, wherein synthesizing, based on the audio clip, the at least one key motion frame into the motion clip matching the audio clip comprises:
performing frame interpolation on the at least one key motion frame when a quantity of key motion frames does not exceed a quantity of audio frames of the audio clip, to obtain the motion clip having a same length as the audio clip; and
creating, when the quantity of key motion frames exceeds the quantity of audio frames, a motion clip having a same length as the audio clip, and filling each frame of the motion clip with a preset motion frame under a preset motion category.

7. The method for generating the motion of the virtual character according to claim 4, wherein generating the motion sequence matching the audio based on each motion clip matching the audio clip of each token comprises:
splicing each motion clip matching each audio clip based on a timestamp order of each audio clip, to obtain a spliced motion sequence; and
performing motion smoothing on each motion frame in the spliced motion sequence, to obtain the motion sequence.

8. The method for generating the motion of the virtual character according to claim 1, wherein retrieving the motion category matching the semantic tag and the motion data belonging to the motion category from the preset motion library comprises:
extracting a semantic feature of the semantic tag;
querying category features of a plurality of candidate categories in the preset motion library; and
determining the motion category from the plurality of candidate categories.

9. The method for generating the motion of the virtual character according to claim 8, comprising:
configuring the motion category matching the semantic tag as a preset motion category when the category features of the plurality of candidate categories and the semantic feature do not meet a similarity condition.

10. A method for constructing a motion library of a virtual character, applied to a computer device, the method comprising:
obtaining a sample motion sequence, reference audio, and reference text of each sample character, the reference text indicating semantic information of the reference audio, and the sample motion sequence being configured for controlling the sample character to perform motions matching the reference audio;
dividing the sample motion sequence into a plurality of sample motion clips based on an association relationship between tokens in the reference text and phones in the reference audio, each sample motion clip being associated with at least one token in the reference text and at least one phone in the reference audio;
clustering each sample motion clip of each sample character based on motion features of the sample motion clips, to obtain a plurality of motion sets, each motion set indicating motion data belonging to a same motion category and belonging to different sample characters; and
constructing a motion library based on the plurality of motion sets.

11. The method for constructing the motion library of the virtual character according to claim 10, wherein dividing the sample motion sequence into the plurality of sample motion clips based on the association relationship between the tokens in the reference text and the phones in the reference audio comprises:
determining, for each token in the reference text, based on the phone associated with the token, a sample audio clip associated with the phone from the reference audio; and
dividing the sample motion sequence into the plurality of sample motion clips based on a timestamp interval of each sample audio clip, the timestamp interval of each sample motion clip being aligned with a timestamp interval of one sample audio clip.

12. The method for constructing the motion library of the virtual character according to claim 10, further comprising:
obtaining, for each motion set, a category feature of the motion category indicated by the motion set, the category feature being an average motion feature of each sample motion clip in the motion set;
determining a contribution score of a motion feature of each sample motion clip in the motion set to the category feature, the contribution score representing a matching degree between the sample motion clip and the motion category;
removing, from the motion set, a sample motion clip whose contribution score meets a removal condition; and
updating the category feature and the contribution score based on a motion set obtained after the removing, iteratively performing a removal operation for a plurality of times, and stopping iteration when an iteration stop condition is met.

13. The method for constructing the motion library of the virtual character according to claim 12, wherein determining the contribution score of the motion feature of each sample motion clip in the motion set to the category feature comprises:
obtaining, for any sample motion clip in the motion set, a motion score of each remaining motion clip other than the sample motion clip, the motion score representing a similarity between the remaining motion clip and the category feature; and
determining, based on the motion score of each remaining motion clip, an intra-class variance after the sample motion clip is excluded, and determining the intra-class variance as the contribution score of the sample motion clip.

14. The method for constructing the motion library of the virtual character according to claim 12, wherein removing, from the motion set, the sample motion clip whose contribution score meets the removal condition comprises:
sorting sample motion clips in the motion set in descending order of the contribution scores, and removing a sample motion clip ranked last in the sort.

15. The method for constructing the motion library of the virtual character according to claim 12, further comprising:
obtaining, for any newly added motion sequence outside a preset motion library, newly added reference audio and newly added reference text associated with the newly added motion sequence;
dividing the newly added motion sequence into a plurality of newly added motion clips based on an association relationship between tokens in the newly added reference text and phones in the newly added reference audio;
for each newly added motion clip, determining, based on a motion feature of the newly added motion clip, a target motion set to which the newly added motion clip belongs from the plurality of motion sets in the preset motion library; and
adding the newly added motion clip to the target motion set, updating the category feature and the contribution score, and removing, from the target motion set, a sample motion clip whose contribution score meets the removal condition.

16. An apparatus for generating a motion of a virtual character, comprising:
a non-transitory memory capable of storing computer-readable instructions; and
at least one processor configured to read the computer-readable instructions, wherein the processor, when executing the computer-readable instructions is configured to:
obtain audio and text of a virtual character, the text indicating semantic information of the audio;
determine a semantic tag of the text based on the text, the semantic tag representing at least one of part-of-speech information of a token in the text or sentiment information expressed by the text;
retrieve a motion category matching the semantic tag and motion data belonging to the motion category from a preset motion library, the preset motion library comprising motion data of the virtual character belonging to a plurality of motion categories; and
generate a motion sequence of the virtual character based on the motion data, the motion sequence being configured for controlling the virtual character to perform motions matching the audio.

17. The apparatus for generating the motion of the virtual character according to claim 16, wherein the processor, when executing the computer-readable instructions to determine the semantic tag of the text based on the text, is configured to:
determining, based on the text, at least one token comprised in the text;
querying, from a part-of-speech table, a part-of-speech tag of each token; and
determining a sentiment tag and the part-of-speech tag of the at least one token as the semantic tag of the text.

18. The apparatus for generating the motion of the virtual character according to claim 16, wherein the processor, when executing the computer-readable instructions to retrieve the motion category matching the semantic tag and the motion data belonging to the motion category from the preset motion library, is configured to:
retrieve, for each token comprised in the text, based on the semantic tag of the token, the motion category matching the semantic tag from the preset motion library; and
retrieving the motion data belonging to the motion category from the preset motion library.

19. The apparatus for generating the motion of the virtual character according to claim 18, wherein the processor, when executing the computer readable instructions to the generate the motion sequence of the virtual character based on the motion data, is configured to:
determine, for each token comprised in the text, based on a phone associated with the token, an audio clip to which the phone belongs; and generating a motion clip matching the audio clip based on the motion data and the audio clip corresponding to the token; and
generate the motion sequence matching the audio based on each motion clip matching the audio clip of each token.

20. The apparatus for generating the motion of the virtual character according to claim 19, wherein the processor, when executing the computer readable instructions to the generate the motion clip matching the audio clip based on the motion data and the audio clip corresponding to the token, is configured to:
determine, from the motion data, at least one key motion frame whose semantic matching degree with the token is highest; and
synthesize, based on the audio clip, the at least one key motion frame into the motion clip matching the audio clip.
